(19) United States
(12) Patent Application Publication
(10) Pub. No.: US 2018/0359768 A1
(43) Pub. Date: Dec. 13, 2018

(54) GROUPING MULTI-USER TRANSMISSIONS BASED ON EXCLUDED MODULATION AND CODING SCHEME SUBSETS

(71) Applicant: QUALCOMM Incorporated, San Diego, CA (US)

(72) Inventors: Xiaolong HUANG, San Jose, CA (US); Hao ZHU, Milpitas, CA (US); Srinivas KATAR, Fremont, CA (US)

(21) Appl. No.: 15/968,623

(22) Filed: May 1, 2018

Related U.S. Application Data
(60) Provisional application No. 62/517,794, filed on Jun. 9, 2017.

(51) Int. Cl. H04W 72/12; H04B 7/0452; H04L 27/26; H04W 52/18

(52) U.S. Cl. CPC H04W 72/121; H04W 52/18; H04L 27/2601; H04B 7/0452

(57) ABSTRACT

In an aspect of the disclosure, a method, a computer-readable medium, and an apparatus are provided. The apparatus may determine a set of STAs for at least one of a MU-MIMO transmission or an OFDMA transmission. In certain aspects, the set of STAs may be associated with a set of acceptable MCSs determined based on MCSs excluded from a union of a plurality of sets of unacceptable MCSs. In certain other aspects, each set of unacceptable MCSs in the plurality of sets of unacceptable MCSs may be associated with a different STA in the set of STAs. The apparatus may transmit the at least one of the MU-MIMO transmission or the OFDMA transmission to the set of STAs.

### CROSS-REFERENCE TO RELATED APPLICATION(S)

This application claims the benefit of U.S. Provisional Application Ser. No. 62/517,794, entitled “GROUPING MULTI-USER TRANSMISSIONS BASED ON EXCLUDED MODULATION AND CODING SCHEME SUBSETS” and filed on Jun. 9, 2017, which is expressly incorporated by reference herein in its entirety.

### BACKGROUND

### Field

The present disclosure relates generally to communication systems, and more particularly, to grouping multi-user transmissions based on excluded modulation and coding scheme (MCS) subsets.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices of aspects of the disclosure each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

Modulation and coding schemes (MCSs) may be used to determine the data rate of a wireless communication using orthogonal frequency division multiplexing (OFDM). An access point (AP) in a wireless communication system may determine the proper MCS to use based on channel conditions as discerned from feedback from, e.g., a mobile station (STA). An MCS may be negotiated during communication between the AP and a STA, and may serve to strike a balance between data rate and an acceptable error rate. Different mobile stations (STAs) in communication with an AP may be assigned different MCSs based on, e.g., channel conditions, a distance from the AP, a maximum acceptable error rate associated with a STA, interference conditions, etc.

Different MCSs (e.g., MCS 0, MCS 1, MCS 2, MCS 3, MCS 4, MCS 5, MCS 6, MCS 7, MCS 8, MCS 9 MCS 10, MCS 11, etc.) may have different transmission powers associated therewith. Generally, the higher the MCS the lower the associated transmission power. For example, the transmission power associated with MCS 9 may be lower than the transmission power associated with MCS 7.

In certain implementations, the AP may select a transmission power associated with the highest indexed MCS for use in transmitting the multi-user transmission to the group of STAs when multiple STAs are grouped together for a downlink multi-user transmission (e.g., a orthogonal frequency division multiple access (OFDMA) and/or multi-user multiple input multiple output (MU-MIMO)).

However, grouping STAs whose transmission powers are significantly different may cause significant throughput degradation. For example, if a first STA with MCS 0 is grouped with a second STA with MCS 11, the AP may reduce the MCS 11 for the first STA to MCS 4, which may incur a loss of 100 Mbps in throughput depending on the resource unit (RU) size for the first STA.

In certain other implementations, the AP may group STAs using fixed MCS subsets when multiple STAs are grouped together for a downlink multi-user transmission. For example, an AP may group STAs with MCS 9, MCS 8, and MCS 7 in a first group, STAs with MCS 6, MCS 5, and MCS 4 in a second group, and STAs with MCS 3, MCS 2, MCS 1, and MCS 0 in a third group. However, grouping STAs for a downlink multi-user transmission using a fixed MCS subset may reduce medium access control (MAC) efficiency and increase scheduling latency.

Thus, there is a need for a mechanism to group STAs for a multi-user transmission that reduces throughput degradation (e.g., data rate degradation) and scheduling latency, and increases MAC efficiency.

The present disclosure provides a solution by grouping STAs for a multi-user transmission based on excluded MCS subsets that are designed to achieve a particular compromise among data rate degradation, MAC efficiency, and scheduling latency.

In an aspect of the disclosure, a method, a computer-readable medium, and an apparatus are provided. The apparatus may determine a set of STAs for at least one of a MU-MIMO transmission or an OFDMA transmission. In certain aspects, the set of STAs may be associated with a set of acceptable MCSs determined based on MCSs excluded from a union of a plurality of sets of unacceptable MCSs. In certain other aspects, each set of unacceptable MCSs in the plurality of sets of unacceptable MCSs may be associated with a different STA in the set of STAs. The apparatus may transmit the at least one of the MU-MIMO transmission or the OFDMA transmission to the set of STAs.

### BRIEF DESCRIPTION OF THE DRAWINGS

FIG. 1 shows an example wireless communication system in which aspects of the present disclosure may be employed.

FIG. 2A is a diagram illustrating a first compromise level of MCS excluded subsets in accordance with certain aspects of the present disclosure.

FIG. 2B is a diagram illustrating a second compromise level of MCS excluded subsets in accordance with certain aspects of the present disclosure.

FIG. 2C is a diagram illustrating a third compromise level of MCS excluded subsets in accordance with certain aspects of the present disclosure.

FIG. 2D is a diagram illustrating an example union of MCS excluded subsets in accordance with certain aspects of the present disclosure.

FIGS. 3A-3D are a diagram illustrating a data flow between an AP, a first group of mobile devices, and a second group of mobile devices in accordance with certain aspects of the present disclosure.

FIG. 4 shows an example functional block diagram of a wireless device that may be configured to group mobile stations for a multi-user transmission based on MCS excluded subsets within the wireless communication system of FIG. 1.

FIGS. 5A-5C are a flowchart of an example method for grouping mobile stations for a multi-user transmission based on MCS excluded subsets in accordance with certain aspects of the present disclosure.

FIG. 6 is a functional block diagram of an example communication device that may be configured to group mobile stations for a multi-user transmission based on MCS excluded subsets in accordance with certain aspects of the present disclosure.

### DETAILED DESCRIPTION

Various aspects of the systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the systems, apparatuses, computer program products, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the aspects. The detailed description and drawings are merely illustrative of the disclosure rather than limiting, the scope of the disclosure being defined by the appended claims and equivalents thereof

Popular wireless network technologies may include various types of WLANs. A WLAN may be used to interconnect nearby devices together, employing widely used networking protocols. The various aspects described herein may apply to any communication standard, such as a wireless protocol, and/or a wired protocol.

In some aspects, wireless signals may be transmitted according to a wireless LAN protocol (e.g., IEEE 802.11) using OFDM, direct-sequence spread spectrum (DSSS) communications, a combination of OFDM and DSSS communications, or other schemes. In one aspect, the physical (PHY) layer may use the DSSS to achieve a data rate (e.g., PHY rate) of, e.g., 11 Mbps. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device coupled to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 protocol, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. The devices may also be used for surveillance, to enable extended-range Internet connectivity (e.g. for use with hotspots), or to implement machine-to-machine communications.

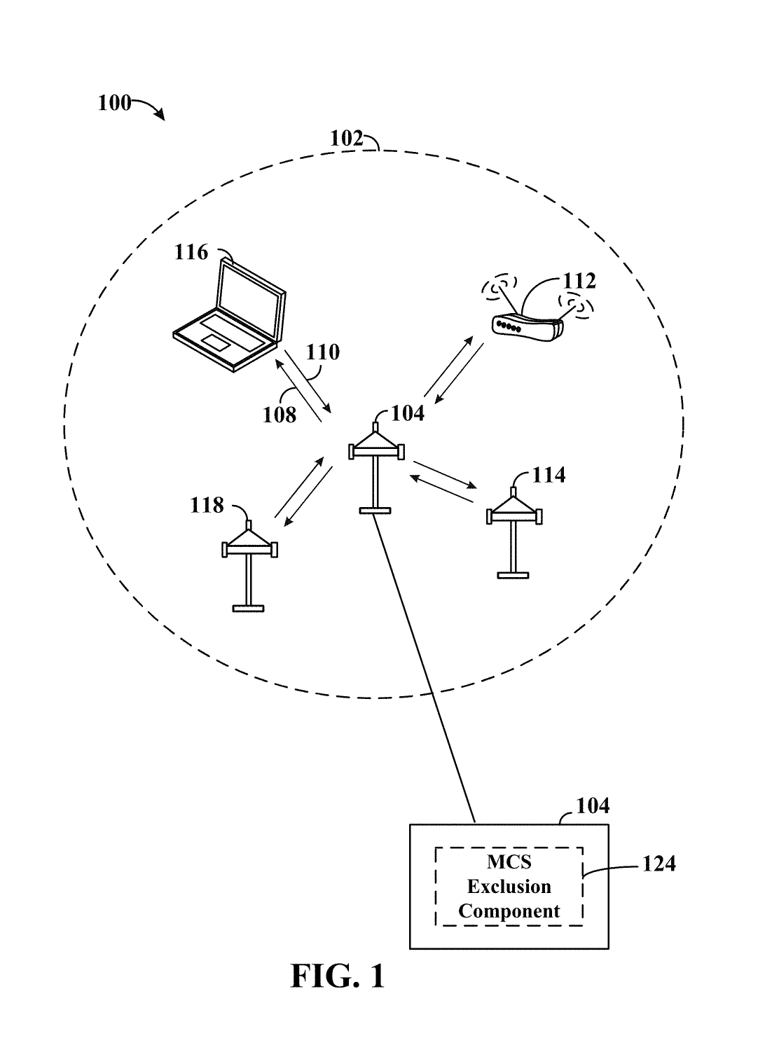

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104 in communication with a plurality of STAs 112, 116.

A variety of processes and methods may be used for transmissions in the wireless communication system 100 between the AP 104 and the STAs. For example, signals may be sent and received between the AP 104 and the STAs in accordance with OFDM/OFDMA techniques. When OFDMA techniques are used for communication, the wireless communication system 100 may be referred to as an OFDM/OFDMA system. Alternatively, signals may be sent and received between the AP 104 and the STAs 112, 116 in accordance with CDMA techniques. When CDMA techniques are used, the wireless communication system 100 may be referred to as a CDMA system.

A communication link that facilitates transmission from the AP 104 to one or more of the STAs 112, 116 may be referred to as a downlink (DL) 108, and a communication link that facilitates transmission from one or more of the STAs 112, 116 to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may increase suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The APs 104, 114, 118 along with the STAs 112, 116 associated with the AP 104 and that use the AP 104 for communication may be referred to as a basic service set (BSS). The wireless communication system 100 may not have a central AP (e.g., AP 104), but rather may function as a peer-to-peer network between the STAs. Accordingly, the functions of the AP 104 described herein may alternatively be performed by one or more of the STAs 112, 116.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 112, 116) may be required to associate with the AP 104 in order to send communications to and/or to receive communications from the AP 104. In one aspect, information for associating may be included in a beacon broadcast by the AP 104. To receive such a beacon, the STA 116 may, for example, perform a broad coverage search over a coverage region. A search may also be performed by the STA 116 by sweeping a coverage region in a lighthouse fashion, for example. After receiving the information for associating, the STA 116 may transmit a reference signal, such as an association probe or request, to the AP 104. In some aspects, the AP 104 may use backhaul services, for example, to communicate with a larger network, such as the Internet or a public switched telephone network (PSTN).

In certain implementations, the AP 104 may include one or more components for performing various functions. For example, the AP 104 may include an MCS exclusion component 124 configured to perform procedures related to grouping STAs for a multi-user transmission based on excluded MCS subsets. In the example, the MCS exclusion component 124 may be configured to determine a set of STAs for at least one of a MU-MIMO transmission or an OFDMA transmission. In certain aspects, the set of STAs may be associated with a set of acceptable MCSs determined based on MCSs excluded from a union of a plurality of sets of unacceptable MCSs. In certain other aspects, each set of unacceptable MCSs in the plurality of sets of unacceptable MCSs may be associated with a different STA in the set of STAs. In certain other aspects, the set of acceptable MCSs associated with the set of STAs may change as additional STAs are included in the set of STAs. In certain configurations, the MCS exclusion component 124 may be configured to determine a set of STAs for at least one of a MU-MIMO transmission or an OFDMA transmission by grouping a first STA in the set of STAs for the at least one of the MU-MIMO transmission or the OFDMA transmission. In certain aspects, the first STA may be associated with a first set of acceptable MCSs and a first set of unacceptable MCSs. In certain other configurations, the MCS exclusion component 124 may be configured to determine a set of STAs for at least one of a MU-MIMO transmission or an OFDMA transmission by grouping a second STA in the set of STAs for the at least one of the MU-MIMO transmission or the OFDMA transmission when a second set of acceptable MCSs associated with the second STA does not include an MCS excluded from the first set of unacceptable MCSs. In certain aspects, the second STA may be associated with a second set of unacceptable MCSs. In certain other configurations, the MCS exclusion component 124 may be configured to determine a set of STAs for at least one of a MU-MIMO transmission or an OFDMA transmission by grouping a third STA in the set of STAs for the at least one of the MU-MIMO transmission or the OFDMA transmission when a third set of acceptable MCSs associated with the third STA does not include an MCS excluded from the first set of unacceptable MCSs or the second set of unacceptable MCSs. In certain other configurations, when the at least one of the MU-MIMO transmission or the OFDMA transmission includes the OFDMA transmission, the MCS exclusion component 124 may be configured to determine the set of STAs for the OFDMA transmission by determining whether a threshold number of STAs associated with the AP has been reached. In certain other configurations, when the at least one of the MU-MIMO transmission or the OFDMA transmission includes the OFDMA transmission, the MCS exclusion component 124 may be configured to determine the set of STAs for the OFDMA transmission by determining the set of STAs for the OFDMA transmission based at least in part on the set of unacceptable MCSs that includes a first number of MCSs upon determining that the threshold number of STAs associated with the AP has not been reached. In certain other configurations, when the at least one of the MU-MIMO transmission or the OFDMA transmission includes the OFDMA transmission, the MCS exclusion component 124 may be configured to determine the set of STAs for the OFDMA transmission by determining the set of STAs for the OFDMA transmission based at least in part on the set of unacceptable MCSs that includes a second number of MCSs upon determining that the threshold number of STAs associated with the AP has been reached. In certain aspects, the first number of MCSs may be greater than the second number of MCSs. In certain other configurations, when the at least one of the MU-MIMO transmission or the OFDMA transmission includes the MU-MIMO transmission, the MCS exclusion component 124 may be configured to determine the set of STAs for the MU-MIMO transmission by determining whether a threshold number of spatial streams used by the AP has been reached. In certain other configurations, when the at least one of the MU-MIMO transmission or the OFDMA transmission includes the MU-MIMO transmission, the MCS exclusion component 124 may be configured to determine the set of STAs for the MU-MIMO transmission by determining the set of STAs for the at least one of the MU-MIMO transmission at least in part on the set of unacceptable MCSs that includes a first number of MCSs upon determining that the threshold number of spatial streams used by the AP has not been reached. In certain other configurations, when the at least one of the MU-MIMO transmission or the OFDMA transmission includes the MU-MIMO transmission, the MCS exclusion component 124 may be configured to determine the set of STAs for the MU-MIMO transmission by determining the set of STAs for the MU-MIMO transmission based at least in part on the set of unacceptable MCSs that includes a second number of MCSs upon determining that the threshold number of spatial streams used by the AP has been reached. In certain aspects, the first number of MCSs may be less than the second number of MCSs. In certain other configurations, when the at least one of the MU-MIMO transmission or the OFDMA transmission includes the MU-MIMO transmission, the MCS exclusion component 124 may be configured to determine the set of STAs for the MU-MIMO transmission by removing at least one STA from the set of STAs upon determining that the threshold number of spatial streams used by the AP has been reached. In certain other configurations, the MCS exclusion component 124 may be configured to transmit the at least one of the MU-MIMO transmission or the OFDMA transmission to the set of STAs. In certain implementations, the MCS exclusion component 124 may be configured to transmit the at least one of the MU-MIMO transmission or the OFDMA transmission to the set of STAs by transmitting the at least one of the MU-MIMO transmission or the OFDMA transmission using a transmission power associated with a highest MCS in the set of acceptable MCSs such that no STA in the set of STAs reduces an associated MCS by more than a threshold MCS value in order to receive the at least one of the MU-MIMO transmission or the OFDMA transmission. In certain other implementations, the MCS exclusion component 124 may be configured to transmit the at least one of the MU-MIMO transmission or the OFDMA transmission to the set of STAs by transmitting the at least one of the MU-MIMO transmission or the OFDMA transmission using a transmission power associated with a highest MCS in the set of acceptable MCSs such that no STA is removed from the set of STAs due to a transmission power reduction or an MCS reduction. In certain other implementations, the MCS exclusion component 124 may be configured to transmit the at least one of the MU-MIMO transmission or the OFDMA transmission to the set of STAs by transmitting the at least one of the MU-MIMO transmission or the OFDMA transmission using a transmission power associated with a highest MCS in the set of acceptable MCSs that does not cause a STA with a lowest MCS in the set of acceptable MCSs to be removed from the set of STAs.

In a Wi-Fi network, wireless devices such as APs and STAs may perform a clear channel assessment (CCA) to determine whether a transmission channel is busy or idle for purposes of determining whether data may be transmitted to another wireless device. A CCA has two components: carriers sense (CS) and energy detection. Carrier sense refers to an ability of a wireless device (e.g., AP or STA) to detect and decode incoming Wi-Fi signal preambles, or signal preambles, which enable the receiver to acquire a wireless signal from and synchronize with the transmitter, from other wireless devices. For example, a first AP may broadcast a Wi-Fi signal preamble, and the Wi-Fi signal preamble may be detected by a second AP or a STA. Similarly, a third AP may broadcast a Wi-Fi signal preamble, and the Wi-Fi signal preamble may be detected by the second AP. When the second AP detects one or more of the Wi-Fi signal preambles, the second AP may determine that the transmission channel is busy and not transmit data. The CCA may remain busy for the length of a transmission frame associated with the Wi-Fi signal preambles.

The second component of CCA is energy detection, which refers to the ability of a wireless device to detect an energy level present on a transmission channel. The energy level may be based on different interference sources, Wi-Fi transmissions, a noise floor, and/or ambient energy. Wi-Fi transmissions may include unidentifiable Wi-Fi transmissions that have been corrupted or are so weak that the transmission can no longer be decoded. Unlike carrier sense, in which the exact length of time for which a transmission channel is busy may be known, energy detection uses periodic sampling of a transmission channel to determine if the energy level still exists. Additionally, energy detection may require at least one threshold used to determine whether the reported energy level is adequate to report the transmission channel as busy or idle. The threshold energy level may be referred to as the ED level/ED threshold level or the CCA sensitivity level. For example, if an ED level is above a threshold, a wireless device may defer to other devices by refraining from transmitting.

MCSs may be used to determine the data rate of a wireless communication using OFDM. An AP in a wireless communication system may determine the proper MCS to use based on channel conditions as discerned from feedback from, e.g., a STA. A MCS may be negotiated during communication between the AP and a STA, and may serve to strike a balance between maximum possible data rate and maximum acceptable error rate. Different STAs in communication with an AP may be assigned different MCSs based on, e.g., channel conditions, a distance of a STA from the AP, a maximum acceptable error rate associated with a STA, interference conditions, etc.

Different MCSs (e.g., MCS 0, MCS 1, MCS 2, MCS 3, MCS 4, MCS 5, MCS 6, MCS 7, MCS 8, MCS 9 MCS 10, MCS 11, etc.) may have different transmission powers associated therewith and may use different modulation schemes that provide different amounts of data throughput. Generally, the higher the MCS the lower the associated transmission power, and the higher the data throughput. For example, the transmission power associated with MCS 9 may be lower than the transmission power associated with MCS 7, and the modulation scheme associated with MCS 9 may provide a higher data throughput than the modulation scheme associated with MCS 7.

In certain implementations, the AP may select a transmission power associated with the highest MCS for use in transmitting the multi-user transmission to the group of STAs when multiple STAs are grouped together for a downlink multi-user transmission (e.g., a OFDMA and/or MU-MIMO).

However, grouping STAs whose transmission powers are significantly different may cause significant throughput degradation. For example, if a first STA with MCS 0 is grouped with a second STA with MCS 11 are in the same group, the AP may reduce the MCS 11 for the first STA to MCS 4, which may incur a loss of 100 Mbps in throughput depending on the RU size for the first STA.

In addition, under OFDMA, there is almost no throughput gain (e.g., an increase in data rate or data throughput) when grouping more STAs together if the data rate associated with some STAs is reduced due to limiting transmission power. Under MU-MIMO, before all spatial streams (Nss) are utilized, the network throughput may still increase even if the data rate associated with some STAs is reduced due to limiting transmission power, as long as more spatial streams are utilized.

In certain other scenarios, the AP may group STAs using fixed MCS subsets when multiple STAs are grouped together for a downlink multi-user transmission. For example, an AP may group STAs with MCS 9, MCS 8, and MCS 7 in a first group, STAs with MCS 6, MCS 5, and MCS 4 in a second group, and STAs with MCS 3, MCS 2, MCS 1, and MCS 0 in a third group. However, using fixed MCS subsets to group STAs for a downlink multi-user transmission may reduce MAC efficiency and increase scheduling latency.

Thus, there is a need for a mechanism to group STAs for a multi-user transmission that reduces throughput degradation (e.g., data rate degradation) and scheduling latency, and that also increases MAC efficiency.

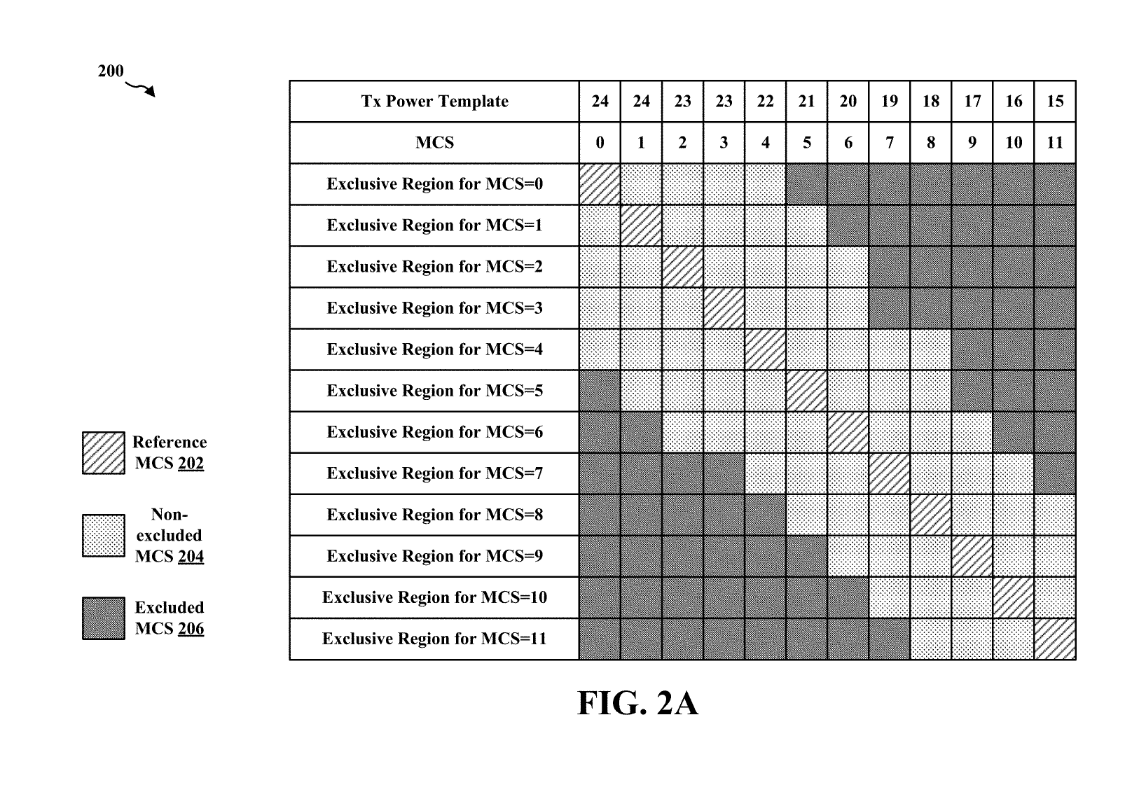

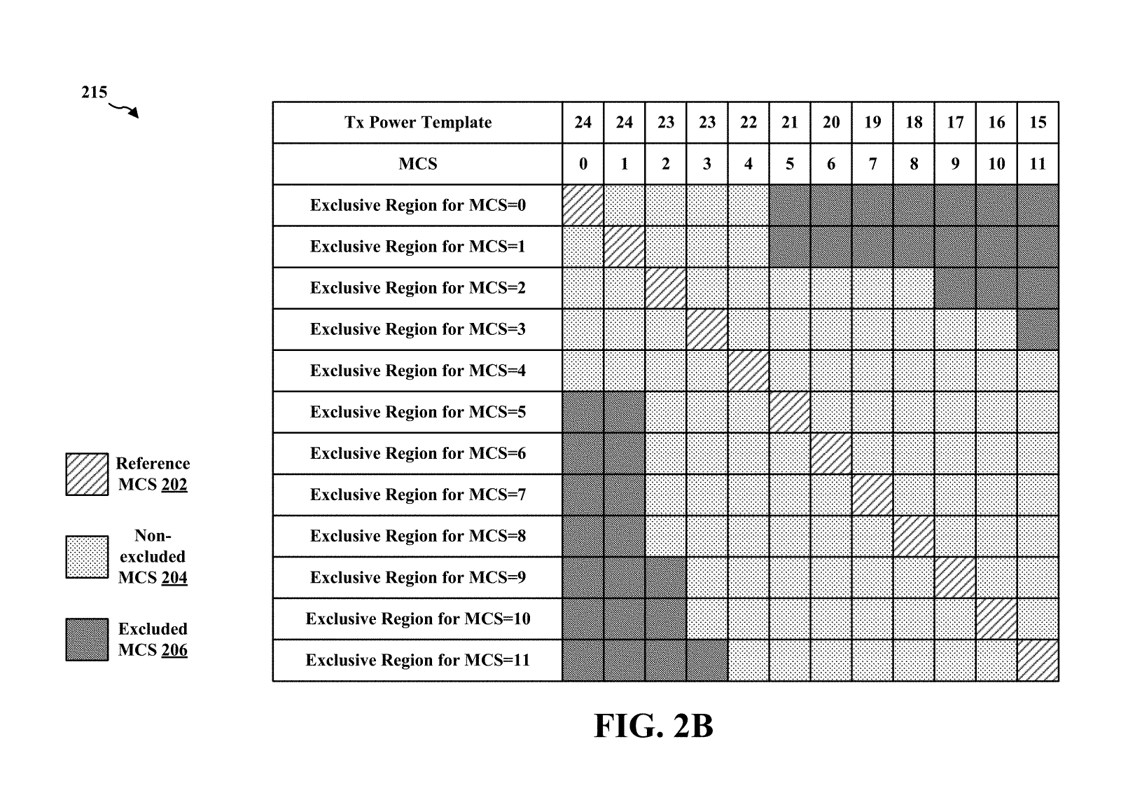

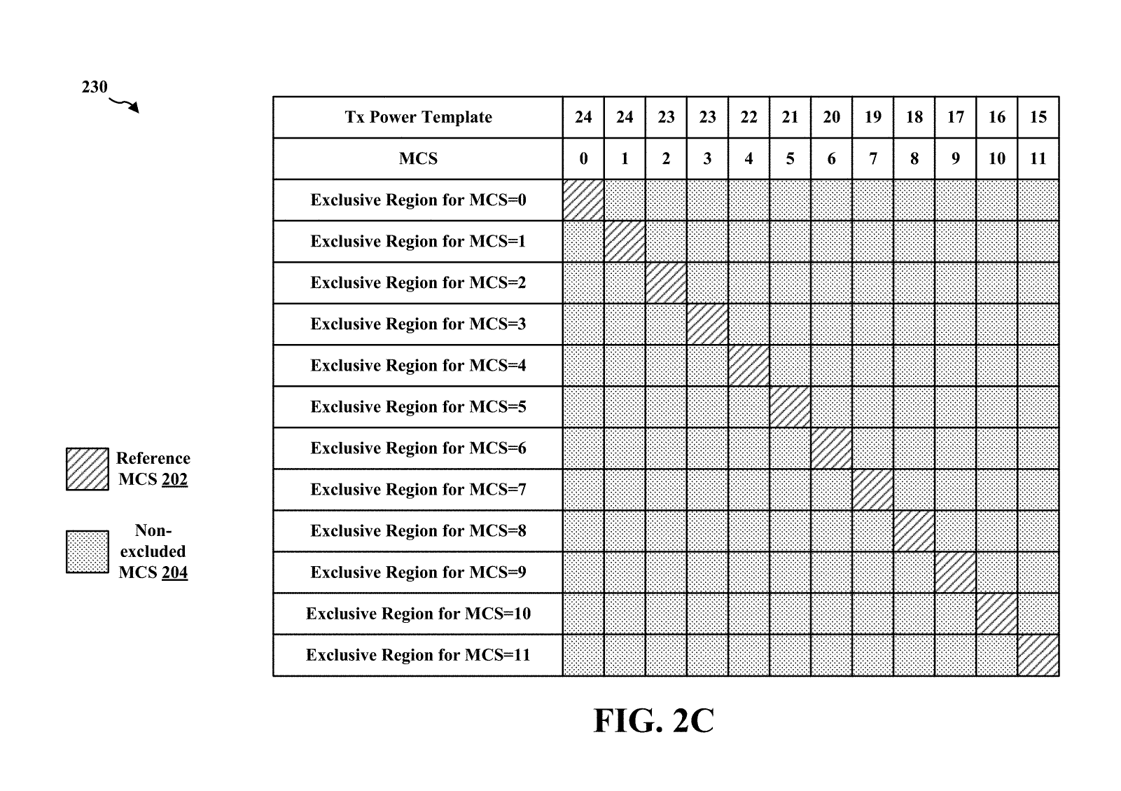

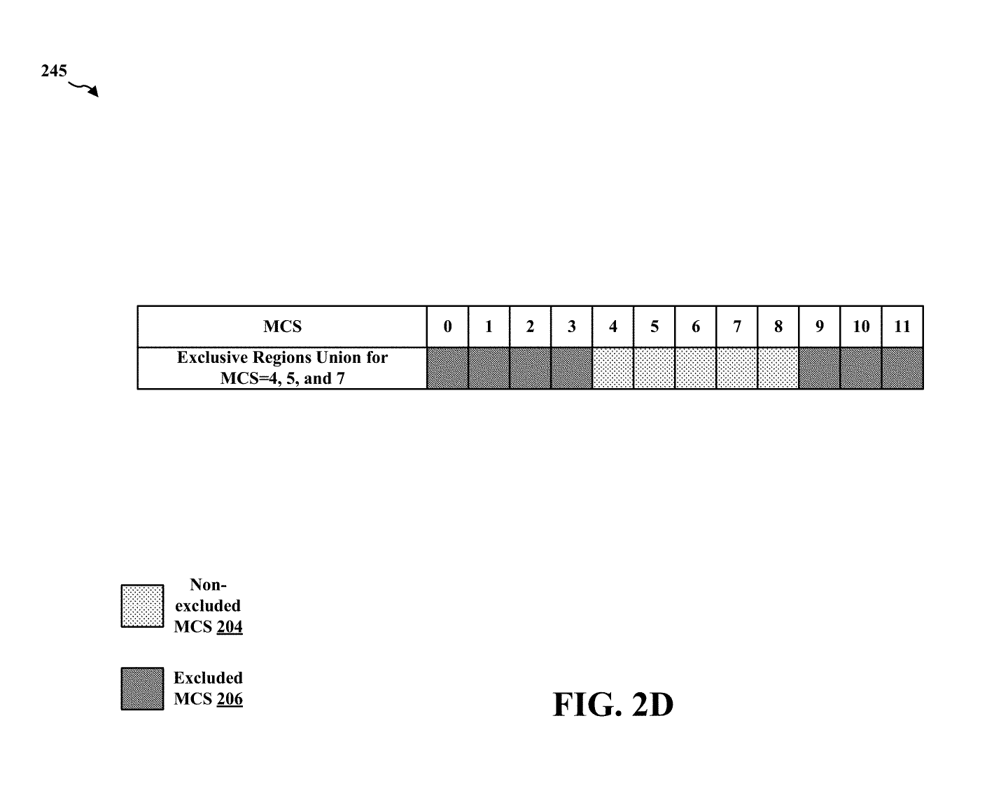

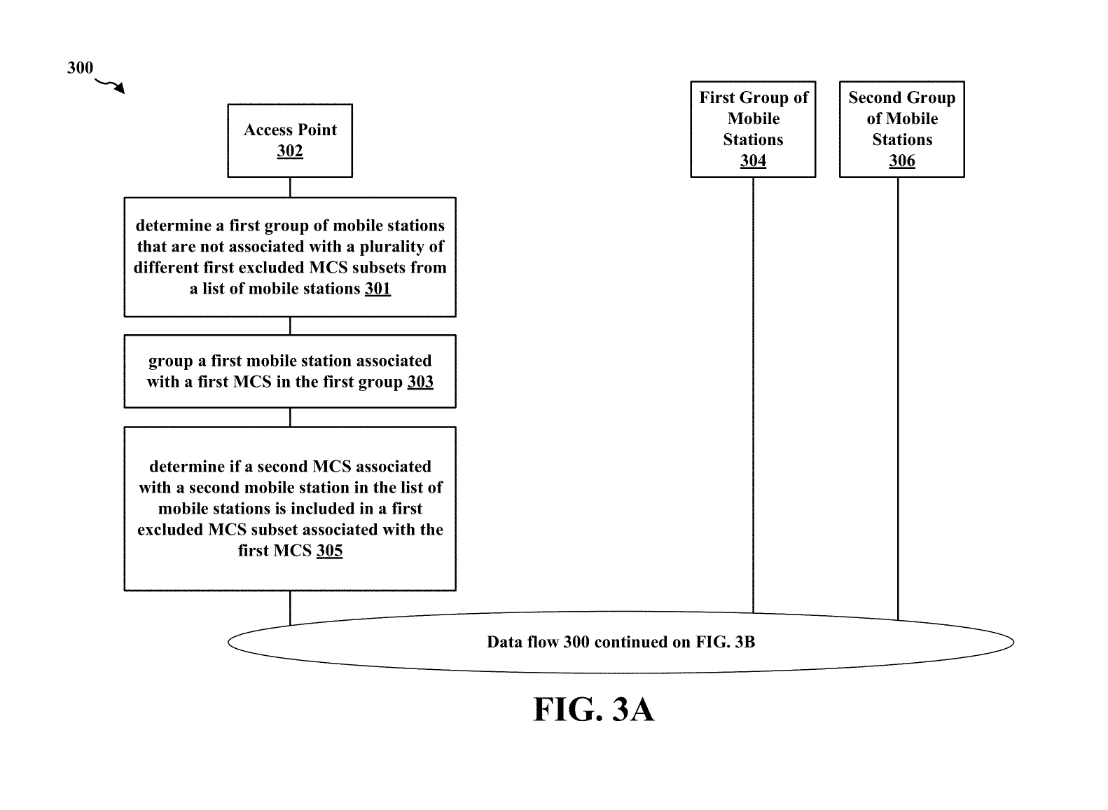

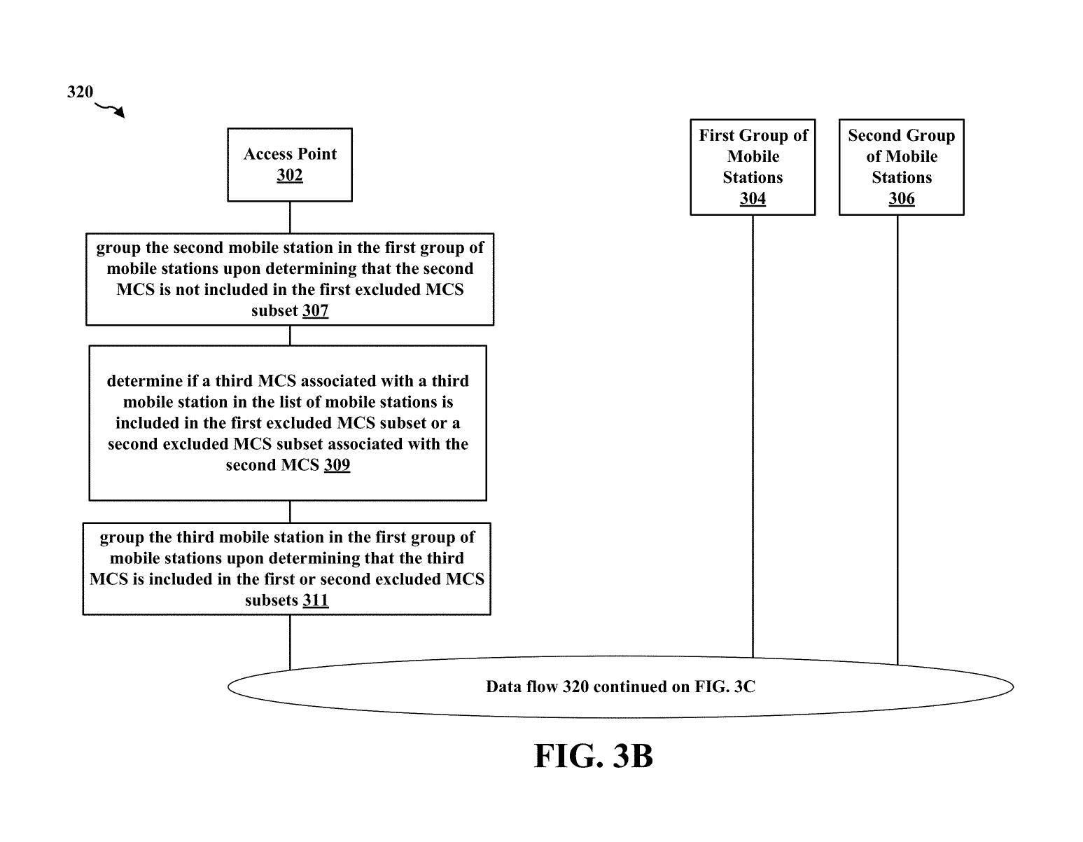

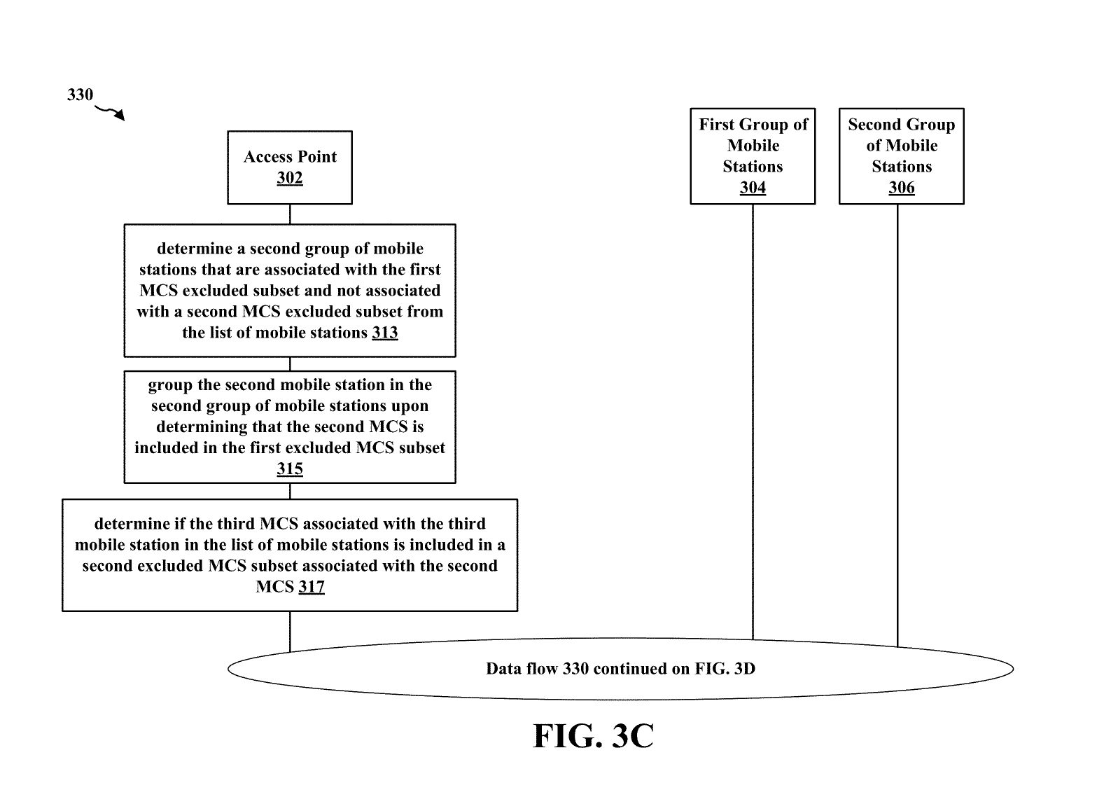

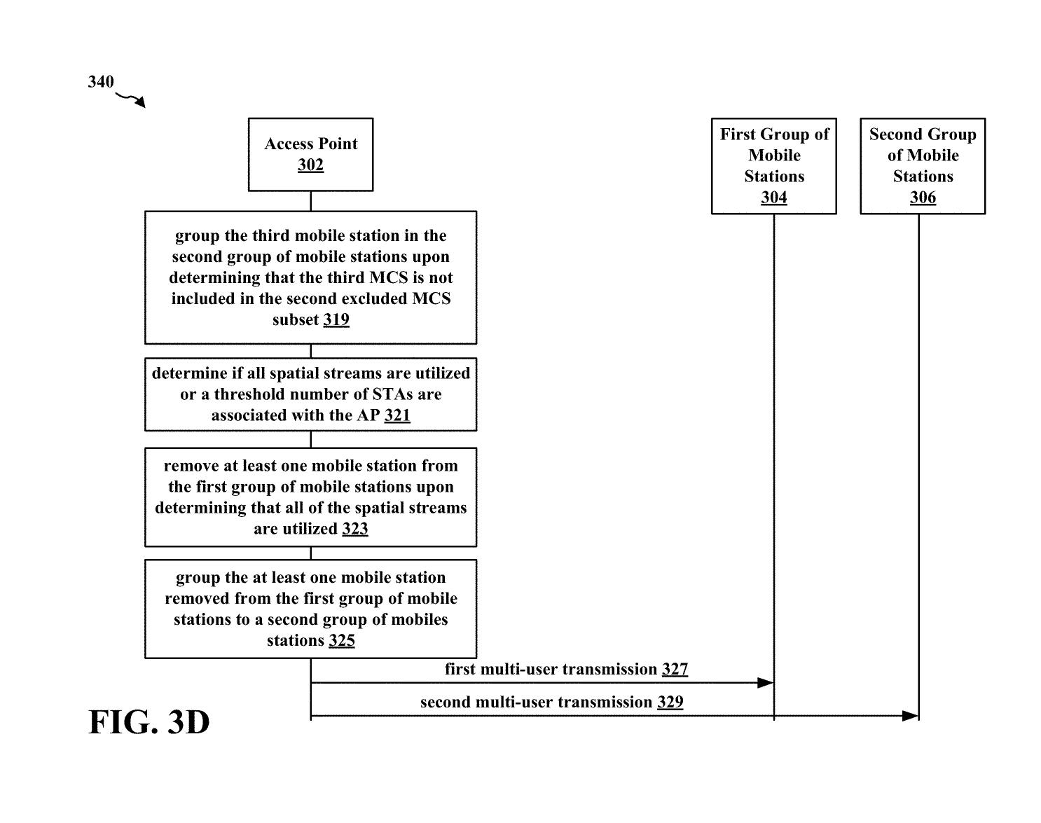

The present disclosure provides a solution by grouping STAs (e.g., less than 37 STAs, 37 STAs, or greater than 37 STAs) for a multi-user transmission based on excluded MCS subsets that are designed to achieve a particular compromise among data rate degradation, MAC efficiency, and scheduling latency. For example, each MCS may be assigned an exclusive MCS region such that if a first STA associated with a first MCS is included in a first mobile station group, no STAs of MCSs in the excluded MCS subsets associated with the first MCS will be grouped in the first mobile station group. The MCS exclusive region may be configured based on a difference between different transmission powers associated with different MCSs. For example, each time a STA is included in a group, the reference MCS set (e.g., the MCSs associated with the different STAs in the group) expands when new STAs with different MCSs are iteratively included into the group of STAs for a multi-user transmission such that the excluded MCS subset for a set of STAs includes a union of all the excluded MCS subsets for each STA in the group, e.g., as described below in connection with any of FIGS. 2A-3D.

FIG. 2A is a diagram 200 illustrating a first compromise level (compromise level 1) of MCS excluded subsets in accordance with certain aspects of the present disclosure. For each reference MCS 202, FIG. 2A illustrates the associated non-excluded MCSs 204 and the excluded MCSs 206 in the horizontal row in which the reference MCS 202 is located. A non-excluded MCS subset includes all non-excluded MCSs 204 associated with a reference MCS 202. An excluded MCS subset includes all excluded MCSs 206 associated with a reference MCS 202.

For example, for MCS 4 at the first compromise level, the non-excluded MCS subset may include, e.g., MCS 0, MCS 1, MCS 2, MCS 3, MCS 5, MCS 6, MCS 7, and MCS 8. The excluded MCS subset for MCS 4 may include, e.g., MCS 9, MCS 10, and MCS 11.

In certain implementations, an AP may be configured to transmit the multi-user transmission using the transmission power associated with the highest MCS STA in the set of STAs when using the first compromise level. The excluded and non-excluded MCS subsets in the first compromise level depicted in FIG. 2A may be selected such that when the transmission power of the highest MCS STA in the set of STAs is used for the multi-user transmission, no STA in the set of STAs will have to reduce its MCS by more than one MCS to properly receive the multi-user transmission. In other words, the difference in transmission power between all MCSs in non-excluded regions for any reference MCS is no greater than a predetermined value (e.g., 2 dB).

As mentioned above, different MCSs (e.g., MCS 0, MCS 1, MCS 2, MCS 3, MCS 4, MCS 5, MCS 6, MCS 7, MCS 8, MCS 9 MCS 10, MCS 11, etc.) may have different transmission powers associated therewith and may use different modulation schemes that provide different amounts of data throughput. Generally, the higher the MCS the lower the associated transmission power, and the higher the data throughput. For example, the transmission power associated with MCS 9 may be lower than the transmission power associated with MCS 7, and the modulation scheme associated with MCS 9 may provide a higher data throughput than the modulation scheme associated with MCS 7.

By way of example, assume that an AP groups a first STA with MCS 7 and a second STA with MCS 9 for a multi-user transmission using the first compromise level depicted in FIG. 2A. In this example, the AP may use the transmission power associated with MCS 9 for the multi-user transmission. Hence, the second STA with MCS 9 may use the modulation scheme associated with MCS 9 for receiving the multi-user transmission. However, the first STA with MCS 7 may need to reduce its MCS to a lower data throughput modulation scheme because the transmission power of the multi-user transmission is reduced in order to properly receive and/or decode the multi-user transmission. If the first STA with MCS 7 maintains the modulation scheme associated with MCS 7, the first STA may be unable to reliably receive the multi-user transmission because the transmission power is lowered.

For example, assume the modulation scheme associated with MCS 7 includes 16-quadrature amplitude modulation (16-QAM) that transmits 4 bits per symbol, and that the modulation scheme associated with MCS 6 includes QPSK that transmits two bits per symbol. In terms of a constellation diagram, 16-QAM uses sixteen points on a square grid with equal horizontal and vertical spacing, and four points per quadrant. When the transmission power for a transmission using 16-QAM is reduced, the first STA with MCS 7 may not be able to properly receive and decode the transmission because the constellation points may shift as a consequence of increased signal noise, interference, etc. (e.g., due to the reduction in transmission power). When there are multiple constellation points per quadrant, as in 16-QAM, the increased signal noise and/or interference may cause the constellation points to shift within the quadrants to a position that is similar to another of the constellation points. Consequently, the first STA may be unable to determine which of the shifted constellation points correspond to the transmitted symbols. Hence, the first STA may reduce its associated MCS from MCS 7 to MCS 6 (e.g., quadrature phase shift keying (QPSK)) in order to increase the chances of properly receiving and decoding the multi-user transmission.

The constellation diagram for QPSK uses four symbols on a square grid with equal horizontal and vertical spacing, and one symbol per quadrant. By using a less robust modulation scheme such as QPSK, even when the transmission power is reduced, the first STA may still receive and decode the multi-user transmission. This is because even if the constellation points for QPSK are shifted within their respective quadrants, the first STA may still be able to determine the originally transmitted symbols because with QPSK there is only a single constellation point per quadrant.

Hence, using the techniques described above in connection with FIG. 2A, all STAs grouped for a multi-user transmission may be able to receive the multi-user transmission even when the transmission power for certain STAs in the group is reduced.

FIG. 2B is a diagram 215 illustrating a second compromise level (compromise level 2) of MCS excluded subsets in accordance with certain aspects of the present disclosure. For each reference MCS 202, FIG. 2B illustrates the associated non-excluded MCSs 204 and the excluded MCSs 206 in the horizontal row in which the reference MCS 202 is located.

For MCS 3 at the second compromise level, the non-excluded MCS subset may include, e.g., MCS 0, MCS 1, MCS 2, MCS 3, MCS 5, MCS 6, MCS 7, MCS 8, MCS 9, and MCS 10. At the second compromise level, the excluded MCS subset may include, e.g., MCS 11.

In certain implementations, when using the second compromise level, an AP may be configured to use the transmission power associated the highest MCS STA in a set of STAs for the multi-user transmission such that no STA is removed from the set of STAs due to a transmission power reduction or an MCS reduction.

For example, assume that an AP groups a first STA with MCS 3 and a second STA with MCS 10 for a multi-user transmission. The AP may use the transmission power associated with the second STA with MCS 10 to transmit the multi-user transmission. In addition, the transmission power difference between MCS 3 and MCS 10 may be 8 dBm, and the transmission power difference between MCS 0 and MCS 3 may be 9 dBm. Because the transmission power associated with the first STA with MCS 3 is reduced by less than 9 dBm, the first STA may reduce its MCS to MCS 0, and thus, remain in the group.

However, if the transmission power associated with MCS 3 is reduced by a value greater than or equal to 9 dBm (e.g., if the transmission power difference between MCS 3 and MCS 10 is greater than or equal to 9 dBm), the first STA may be removed from the group since the STA cannot reduce its MCS lower than MCS 0. The excluded MCS subsets of the second compromise level are selected such that no STA may be removed from the group due to reducing transmission power, e.g., the transmission power difference between the highest MCS STA in a group and all other STAs in the group is less than the transmission power difference between MCS 0 and all other STAs in the group.

The second compromise level may be less stringent than using the first compromise level. However, using the second compromise level may compromise the throughput of the mobile stations with lower MCSs in a group, but not compromise the throughput of the mobile stations with the higher MCSs in the group.

FIG. 2C is a diagram 230 illustrating a third compromise level (compromise level 3) of MCS excluded subsets in accordance with certain aspects of the present disclosure. For each reference MCS 202, FIG. 2C illustrates that all MCSs are non-excluded MCSs 204. In other words, there are no excluded MCS subsets associated with any of the MCSs at the third compromise level. The third compromise level may be less stringent than both the first compromise level and the second compromise level. However, using the third compromise level may compromise the throughput for the all mobile stations in a group.

In certain implementations, the third compromise level may configure an AP to use the transmission power of the highest MCS in a mobile station group without pushing the lowest MCS mobile station out of the group.

For example, assume that an AP groups a first STA with MCS 2, a second STA with

MCS 5, and a third STA with MCS 7 for a multi-user transmission. The AP may use the transmission power associated with the MCS 7 if the transmission power difference between MCS 2 and MCS 7 is less than the transmission power difference of MCS 0 and MCS 2.

However, if the transmission power difference between MCS 2 and MCS 7 is greater than or equal to the transmission power difference between MCS 0 and MCS 2, then the AP may use the transmission power of MCS 5 for the multi-user transmission so long as the power difference between MCS 2 and MCS 5 is less than the power difference between MCS 0 and MCS 2.

Further, if the transmission power difference between MCS 2 and MCS 7 and the transmission power difference between MCS 2 and MCS 5 are both greater than or equal to the transmission power difference of MCS 0 and MCS 2, the AP may use the transmission power associated with MCS 2 for the multi-user transmission.

FIG. 2D is a diagram illustrating a union of MCS excluded subsets 245 in accordance with certain aspects of the present disclosure. The example union of MCS excluded subsets 245 is a union of the MCS excluded subsets of MCS 4, MCS 5, and MCS 7 at the first comprise level as seen in FIG. 2A.

At the first compromise level (e.g., see FIG. 2A), when a first STA with MCS 4 is the highest priority STA in the list, the AP may group the first STA with MCS 4 into a group of STAs for a multi-user transmission. The MCS excluded subset associated with MCS 4 includes MCS 9, MCS 10, and MCS 11.

When a second STA with MCS 5 is the second highest priority STA in the list, the AP may group the second STA with MCS 5 into the group of STAs for the multi-user transmission because MCS 5 is not excluded by the MCS excluded subset associated with MCS 4, which is already in the group of STAs. Similarly, the MCS excluded subset associated with MCS 5 also includes MCS 9, MCS 10, and MCS 11, and hence, the union of the MCS excluded subsets associated with MCS 4 and MCS 5 includes MCS 9, MCS 10, MCS 11.

When a third STA with MCS 7 is the third highest priority STA in the list, the AP may group the third STA with MCS 7 into the group of STAs for the multi-user transmission because MCS 7 is not excluded by the union of MCS excluded subsets associated with MCS 4 and MCS 5. The MCS excluded subset associated with MCS 7 includes MCS 0, MCS 1, MCS 2, MCS 3, and MCS 11.

Thus, the union of MCS excluded subsets 345 for MCS 4, MCS 5, and MCS 7 includes MCS 0, MCS 1, MCS 2, MCS 3, MCS 9, MCS 10, and MCS 11. In other words, no STAs with MCS 0, MCS 1, MCS 2, MCS 3, MCS 9, MCS 10, or MCS 11 may be included in a group that includes STAs with MCS 4, MCS 5, and MCS 7.

FIGS. 3A-3D illustrate a data flow 300, 320, 330, 340 between an AP 302, a first group of mobile stations 304, and a second group of mobile stations 306 in accordance with certain aspects of the present disclosure. The AP 302 may correspond to, e.g., AP 104, wireless communication device 402, 600. The first group of mobile stations 304 may correspond to, e.g., a first group of one or more STAs. The second group of mobile stations 306 may correspond to, e.g., a second group of one or more STAs that may be different than the first group of STAs.

Referring to FIG. 3A, the AP 302 may determine 301 a first group of mobile stations 304 from a list of mobile stations. In certain implementations, each mobile station in the first group of mobile stations may not be associated with a plurality of different first excluded MCS subsets. The list of mobile stations may include a ranking of mobile stations based at least in part on a quality of service (QoS) requirement associated with each mobile station in the list of mobile stations. In one aspect, the QoS requirement may include a latency requirement associated with a data transmission. Additionally and/or alternatively, the QoS requirement may include a data throughput requirement.

For example, a mobile station with the most stringent latency requirement and/or data throughput requirement may be assigned the highest rank in the list by the AP 302. A mobile station with the second most stringent latency requirement and/or data throughput requirement may be assigned the second highest rank in the list by the AP 302. A mobile station with the least stringent latency requirement and/or data throughput requirement may be assigned the lowest rank in the list by the AP 302.

In certain configurations, the excluded MCS subset associated with a reference MCS (e.g., a first MCS associated with a first mobile station in the first group of mobile stations 304) may be designed to achieve different compromise levels among data rate degradation, MAC efficiency, and scheduling latency as discussed supra with respect to FIGS. 2A, 2B, and 2C.

For example, the number of MCSs included in an excluded MCS subset may be associated with at least one of system overhead or a number of mobile stations in a wireless communication system and/or in communication with the AP 302. In addition, the number of MCSs included in an excluded MCS subset may dynamically shift between different compromise levels based on a change in system overhead or a change in the number of mobile stations in the wireless communication system and/or in communication with the AP 302. In other words, when system overhead is less than an overhead threshold and/or the number of mobile stations in communication with the AP 302 is less than a threshold number of mobile stations, the number of MCSs in an excluded MCS subset may be smaller than if the system overhead is higher and/or the number of mobile stations in communication with the AP 302 is greater than the threshold number of STAs.

In certain other configurations, the AP 302 may group 303 a first mobile station in the list of mobile stations in the first group of mobile stations 304. In one aspect, the first mobile station may be associated with a first MCS. For example, the AP 302 may group the mobile station with the highest rank in the list (e.g., the first mobile station) in the first group of mobile stations 304.

In certain other configurations, the AP 302 may determine 305 if a second MCS associated with a second mobile station in the list of mobile stations is included in the first excluded MCS subset associated with the first MCS.

For example, assume that the second mobile station (e.g., the mobile station with the second highest rank in the list) is associated with MCS 7. In addition, assume that the first mobile station is associated with MCS 5, and that the first excluded MCS subset associated with MCS 5 includes MCS 0, MCS 9, MCS 10, and MCS 11. Because MCS 7 is not included in the first excluded MCS subset associated with MCS 5, the AP 302 may determine 305 that the second mobile station can be grouped in the first group of mobile stations 304.

Referring to FIG. 3B, the AP 302 may group 307 the second mobile station in the first group of mobile stations 304 upon determining that the second MCS is not included in the first excluded MCS subset.

In certain configurations, upon determining that the second MCS is not included in the first excluded MCS subset, the AP 302 may determine 309 if a third mobile station of the list of mobile stations can be grouped in the first group of mobile stations 304 based at least in part on one or more of the first excluded MCS subset, a second excluded MCS subset associated with the second mobile station, and a third MCS associated with the third mobile station.

For example, assume that the third mobile station (e.g., the mobile station with the third highest rank in the list) is associated with MCS 4. In addition, assume that first mobile station is associated with MCS 5, and that the first excluded MCS subset associated with MCS 5 includes MCS 0, MCS 9, MCS 10, and MCS 11. Also assume that the second mobile station is associated with MCS 7, and that the second excluded MCS subset associated with MCS 7 includes MCS 0, MCS 1, MCS 2, MCS 3, and MCS 11. Because MCS 4 is not included in the first excluded MCS subset associated with MCS 5 or in the second excluded MCS subset associated with MCS 7, the AP 302 may determine 305 that the third mobile station can be grouped in the first group of mobile stations 304.

In certain implementations, the AP 302 may group 311 the third mobile station in the first group of mobile stations 304 upon determining that the third MCS is not included in the first excluded MCS subset or the second excluded MCS subset. Alternatively, upon determining that the third mobile station cannot be grouped in the first group of mobile stations 304, the AP 302 may group the third mobile station in the second group of mobile stations 306.

Referring to FIG. 3C, the AP 302 may determine 313 a second group of mobile stations from the list of mobile stations. In one aspect, each mobile station in the second group of mobile stations may be associated with at least one of the plurality of different first excluded MCS subsets and may not be associated with a plurality of different second excluded MCS subsets.

Referring to FIGS. 3A and 3C, when the AP 302 determines 305 that the second MCS is included in the first excluded MCS subset, the AP 302 may group 315 the second mobile station in the second group of mobile stations 306.

For example, assume that the second mobile station (e.g., the mobile station with the second highest rank in the list) is associated with MCS 9. In addition, assume that the first mobile station is associated with MCS 5, and that the first excluded MCS subset associated with MCS 5 includes MCS 0, MCS 9, MCS 10, and MCS 11. Because MCS 9 is included in the first excluded MCS subset associated with MCS 5, the AP 302 may determine 305 that the second mobile station cannot be grouped in the first group of mobile stations 304. Hence, the AP 302 may group 315 the second mobile station in the second group of mobile stations 306.

Referring to FIGS. 3A-3C, when the AP 302 determines 305 that the second MCS is included in the first excluded MCS subset and the AP 302 determines 309 that the third MCS is included in the first excluded MCS subset, the AP 302 may determine 317 if the third mobile station of the list of mobile stations can be grouped in the second group of mobile stations 306 based at least in part on the second excluded MCS subset associated with the second mobile station and a third MCS associated with the third mobile station.

For example, assume that the third mobile station (e.g., the mobile station with the third highest rank in the list) is associated with MCS 11. In addition, assume that the second mobile station is associated with MCS 9, and that the second excluded MCS subset associated with MCS 9 includes MCS 0, MCS 1, MCS 2, MCS 3, MCS 4, and MCS 5. Because MCS 11 is not included in the second excluded MCS subset associated with MCS 9, the AP 302 may determine 317 that the third mobile station can be grouped in the second group of mobile stations 306.

Referring to FIG. 3D, the AP 302 may group 319 the third mobile station in the second group of mobile stations upon determining that the third MCS is not included in the second excluded MCS subset.

In certain implementations, the AP 302 may determine 321 if all spatial streams are utilized and/or if a threshold number of STAs communicating with the AP 302 has been reached. For example, the AP 302 may determine 321 if all spatial streams are utilized prior to the AP 302 transmitting a MU-MIMO transmission to a group of mobile stations, and the AP 302 may determine 321 if the threshold number of STAs communicating with the AP 302 has been reached prior to transmitting a OFDMA transmission.

In certain implementations, when the AP 302 determines 321 that the threshold number of STAs communicating with the AP 302 has not been reached, the AP 302 may determine the set of STAs for the OFDMA transmission based at least in part on the set of unacceptable MCSs that includes a first number of MCSs (e.g., compromise level 1—see FIG. 2A).

In certain other implementations, when the AP 302 determines 321 that the threshold number of STAs communicating with the AP 302 has been reached, the AP 302 may determine the set of STAs for the OFDMA transmission based at least in part on the set of unacceptable MCSs that includes a second number of MCSs (e.g., compromise level 2—see FIG. 2B), where the second number of MCSs is less than the first number of MCSs.

In certain other implementations, when the AP 302 determines 321 that all spatial streams are not utilized, a first number of MCS may be included in the plurality of different first excluded MCS subsets (e.g., compromise level 2—see FIG. 2B).

In certain other implementations, when the AP 302 determines 321 that all spatial streams are utilized, a second number of MCSs that is less than the first number of MCSs may be included in the plurality of different first excluded MCS subsets (e.g., compromise level 1—see FIG. 2A).

In certain implementations, the AP 302 may remove 323 at least one mobile station from the first group of mobile stations upon determining that all of the spatial streams are utilized. For example, assume that a first mobile station with MCS 3, a second mobile station with MCS 4, and a third mobile station with MCS 8 are initially grouped together for a multi-user transmission based on compromise level 2 Excluded MCS subsets (e.g., before all of the spatial streams are utilized—see FIG. 2B). When the AP 302 determines that all of the spatial streams have been utilized, the AP 302 may switch from compromise level 2 to compromise level 1, and remove the third mobile station from the group since MCS 8 is part of the union of excluded MCS subsets associated with MCS 3 and MCS 4 when using compromise level 1 (e.g., the union includes MCS 7, MCS, 8, MCS 9, MCS, 10, MCS 11).

The AP 302 may group 325 the at least one mobile station removed from the first group of mobile stations to a second group of mobile stations. Referring to the example discussed supra with respect to 323, the AP 302 may group the third mobile station with MCS 8 in a second group of mobile stations that does not exclude MCS 8 based on the excluded MCS subsets of the second group.

The AP 302 may transmit a first multi-user transmission 327 to the first group of mobile stations 304 and a second multi-user transmission 329 to the second group of mobile stations 306. In certain configurations, one or more of the first multi-user transmission 327 or the second multi-user transmission 329 may include an MU-MIMO transmission. In certain other implementations, one or more of the first multi-user transmission 327 or the second multi-user transmission 329 may include an OFDMA transmission.

Using the data flow 300 discussed supra may provide a mechanism to group STAs for a multi-user transmission that reduces data rate degradation and scheduling latency, and increases MAC efficiency.

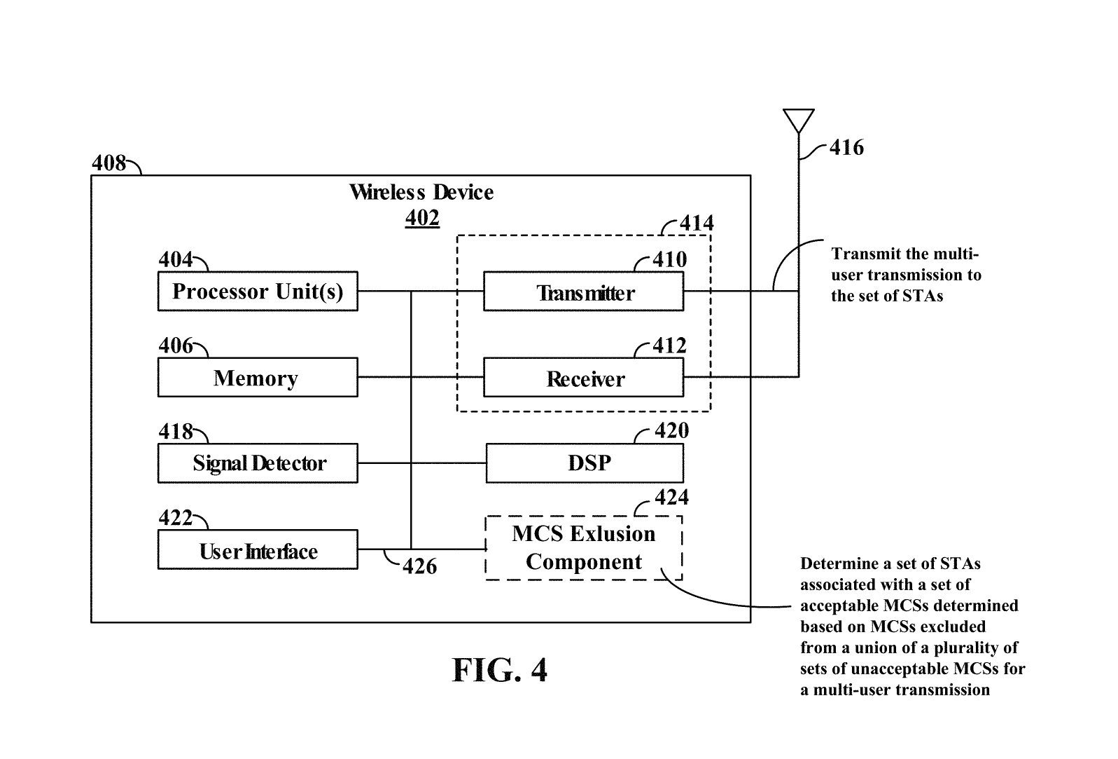

FIG. 4 shows an example functional block diagram of a wireless communication device 402 that may be configured to group STAs for a multi-user transmission based on excluded MCS subsets that are designed to achieve a particular compromise among data rate degradation, MAC efficiency, and scheduling latency within the wireless communication system 100 of FIG. 1. The wireless communication device 402 is an example of a device that may be configured to implement the various methods described herein. For example, the wireless communication device 402 may correspond to, e.g., AP 104, AP 302, the wireless communication device 600.

The wireless communication device 402 may include a processor 404 which controls operation of the wireless communication device 402. The processor 404 may also be referred to as a central processing unit (CPU). Memory 406, which may include both read-only memory (ROM) and random access memory (RAM), may provide instructions and data to the processor 404. A portion of the memory 406 may also include non-volatile random access memory (NVRAM). The processor 404 may perform logical and arithmetic operations based on program instructions stored within the memory 406. The instructions in the memory 406 may be executable (by the processor 404, for example) to implement the methods described herein.

The processor 404 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, may cause the processing system to perform the various functions described herein.

The wireless communication device 402 may also include a housing 408, and the wireless communication device 402 may include a transmitter 410 and/or a receiver 412 to allow transmission and reception of data between the wireless communication device 402 (e.g., an AP) and a remote device (e.g., a STA). The transmitter 410 and the receiver 412 may be combined into a transceiver 414. An antenna 416 may be attached to the housing 408 and electrically coupled to the transceiver 414. The wireless communication device 402 may also include multiple transmitters, multiple receivers, multiple transceivers, and/or multiple antennas.

The wireless communication device 402 may also include a signal detector 418 that may be used to detect and quantify the level of signals received by the transceiver 414 or the receiver 412. The signal detector 418 may detect such signals as total energy, energy per subcarrier per symbol, power spectral density, and other signals. The wireless communication device 402 may also include a digital signal processor (DSP) 420 for use in processing signals. The DSP 420 may be configured to generate a packet for transmission. In some aspects, the packet may comprise a physical layer convergence procedure (PLCP) protocol data unit (PPDU).

The wireless communication device 402 may further comprise a user interface 422 in some aspects. The user interface 422 may comprise a keypad, a microphone, a speaker, and/or a display. The user interface 422 may include any element or component that conveys information to a user of the wireless communication device 402 and/or receives input from the user.

When the wireless communication device 402 is implemented as an AP (e.g., the AP 104, 302, wireless communication device 600), the wireless communication device 402 may also comprise an MCS exclusion component 424. For example, MCS exclusion component 424 may be configured to perform procedures related to grouping STAs for a multi-user transmission based on excluded MCS subsets that are designed to achieve a particular compromise among data rate degradation, MAC efficiency, and scheduling latency. In the example, the MCS exclusion component 424 may be configured to determine a set of STAs for at least one of a MU-MIMO transmission or an OFDMA transmission. In certain aspects, the set of STAs may be associated with a set of acceptable MCSs determined based on MCSs excluded from a union of a plurality of sets of unacceptable MCSs. In certain other aspects, each set of unacceptable MCSs in the plurality of sets of unacceptable MCSs may be associated with a different STA in the set of STAs. In certain other aspects, the set of acceptable MCSs associated with the set of STAs may change as additional STAs are included in the set of STAs. In certain configurations, the MCS exclusion component 424 may be configured to determine a set of STAs for at least one of a MU-MIMO transmission or an OFDMA transmission by grouping a first STA in the set of STAs for the at least one of the MU-MIMO transmission or the OFDMA transmission. In certain aspects, the first STA may be associated with a first set of acceptable MCSs and a first set of unacceptable MCSs. In certain other configurations, the MCS exclusion component 424 may be configured to determine a set of STAs for at least one of a MU-MIMO transmission or an OFDMA transmission by grouping a second STA in the set of STAs for the at least one of the MU-MIMO transmission or the OFDMA transmission when a second set of acceptable MCSs associated with the second STA does not include an MCS excluded from the first set of unacceptable MCSs. In certain aspects, the second STA may be associated with a second set of unacceptable MCSs. In certain other configurations, the MCS exclusion component 424 may be configured to determine a set of STAs for at least one of a MU-MIMO transmission or an OFDMA transmission by grouping a third STA in the set of STAs for the at least one of the MU-MIMO transmission or the OFDMA transmission when a third set of acceptable MCSs associated with the third STA does not include an MCS excluded from the first set of unacceptable MCSs or the second set of unacceptable MCSs. In certain other configurations, when the at least one of the MU-MIMO transmission or the OFDMA transmission includes the OFDMA transmission, the MCS exclusion component 424 may be configured to determine the set of STAs for the OFDMA transmission by determining whether a threshold number of STAs associated with the AP has been reached. In certain other configurations, when the at least one of the MU-MIMO transmission or the OFDMA transmission includes the OFDMA transmission, the MCS exclusion component 424 may be configured to determine the set of STAs for the OFDMA transmission by determining the set of STAs for the OFDMA transmission based at least in part on the set of unacceptable MCSs that includes a first number of MCSs upon determining that the threshold number of STAs associated with the AP has not been reached. In certain other configurations, when the at least one of the MU-MIMO transmission or the OFDMA transmission includes the OFDMA transmission, the MCS exclusion component 424 may be configured to determine the set of STAs for the OFDMA transmission by determining the set of STAs for the OFDMA transmission based at least in part on the set of unacceptable MCSs that includes a second number of MCSs upon determining that the threshold number of STAs associated with the AP has been reached. In certain aspects, the first number of MCSs may be greater than the second number of MCSs. In certain other configurations, when the at least one of the MU-MIMO transmission or the OFDMA transmission includes the MU-MIMO transmission, the MCS exclusion component 424 may be configured to determine the set of STAs for the MU-MIMO transmission by determining whether a threshold number of spatial streams used by the AP has been reached. In certain other configurations, when the at least one of the MU-MIMO transmission or the OFDMA transmission includes the MU-MIMO transmission, the MCS exclusion component 424 may be configured to determine the set of STAs for the MU-MIMO transmission by determining the set of STAs for the at least one of the MU-MIMO transmission at least in part on the set of unacceptable MCSs that includes a first number of MCSs upon determining that the threshold number of spatial streams used by the AP has not been reached. In certain other configurations, when the at least one of the MU-MIMO transmission or the OFDMA transmission includes the MU-MIMO transmission, the MCS exclusion component 424 may be configured to determine the set of STAs for the MU-MIMO transmission by determining the set of STAs for the MU-MIMO transmission based at least in part on the set of unacceptable MCSs that includes a second number of MCSs upon determining that the threshold number of spatial streams used by the AP has been reached. In certain aspects, the first number of MCSs may be less than the second number of MCSs. In certain other configurations, when the at least one of the MU-MIMO transmission or the OFDMA transmission includes the MU-MIMO transmission, the MCS exclusion component 424 may be configured to determine the set of STAs for the MU-MIMO transmission by removing at least one STA from the set of STAs upon determining that the threshold number of spatial streams used by the AP has been reached. In certain other configurations, the MCS exclusion component 424 may be configured to transmit the at least one of the MU-MIMO transmission or the OFDMA transmission to the set of STAs. In certain implementations, the MCS exclusion component 424 may be configured to transmit the at least one of the MU-MIMO transmission or the OFDMA transmission to the set of STAs by transmitting the at least one of the MU-MIMO transmission or the OFDMA transmission using a transmission power associated with a highest MCS in the set of acceptable MCSs such that no STA in the set of STAs reduces an associated MCS by more than a threshold MCS value in order to receive the at least one of the MU-MIMO transmission or the OFDMA transmission. In certain other implementations, the MCS exclusion component 424 may be configured to transmit the at least one of the MU-MIMO transmission or the OFDMA transmission to the set of STAs by transmitting the at least one of the MU-MIMO transmission or the OFDMA transmission using a transmission power associated with a highest MCS in the set of acceptable MCSs such that no STA is removed from the set of STAs due to a transmission power reduction or an MCS reduction. In certain other implementations, the MCS exclusion component 424 may be configured to transmit the at least one of the MU-MIMO transmission or the OFDMA transmission to the set of STAs by transmitting the at least one of the MU-MIMO transmission or the OFDMA transmission using a transmission power associated with a highest MCS in the set of acceptable MCSs that does not cause a STA with a lowest MCS in the set of acceptable MCSs to be removed from the set of STAs.

The various components of the wireless communication device 402 may be coupled together by a bus system 426. The bus system 426 may include a data bus, for example, as well as a power bus, a control signal bus, and a status signal bus in addition to the data bus. Components of the wireless communication device 402 may be coupled together or accept or provide inputs to each other using some other mechanism.

Although a number of separate components are illustrated in FIG. 4, one or more of the components may be combined or commonly implemented. For example, the processor 404 may be used to implement the functionality described above with respect to the processor 404, but also to implement the functionality described above with respect to the signal detector 418, the DSP 420, the user interface 422, and/or the MCS exclusion component 424. Further, each of the components illustrated in FIG. 4 may be implemented using a plurality of separate elements.

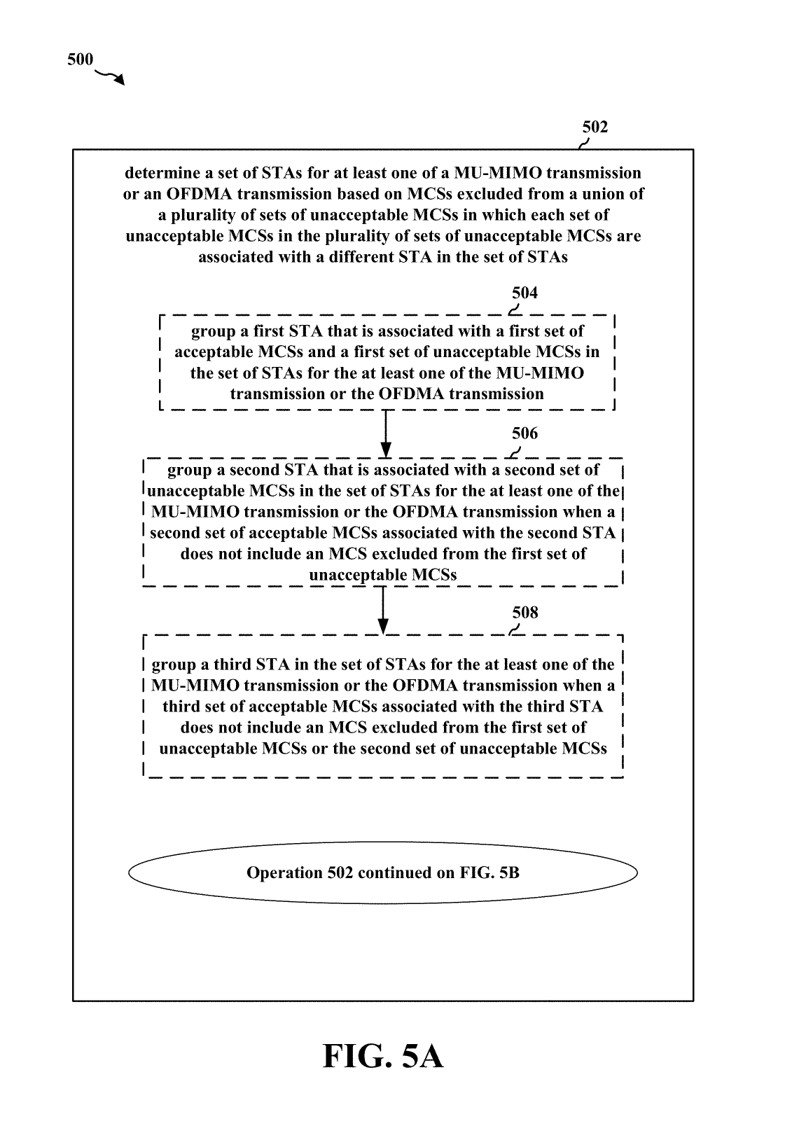

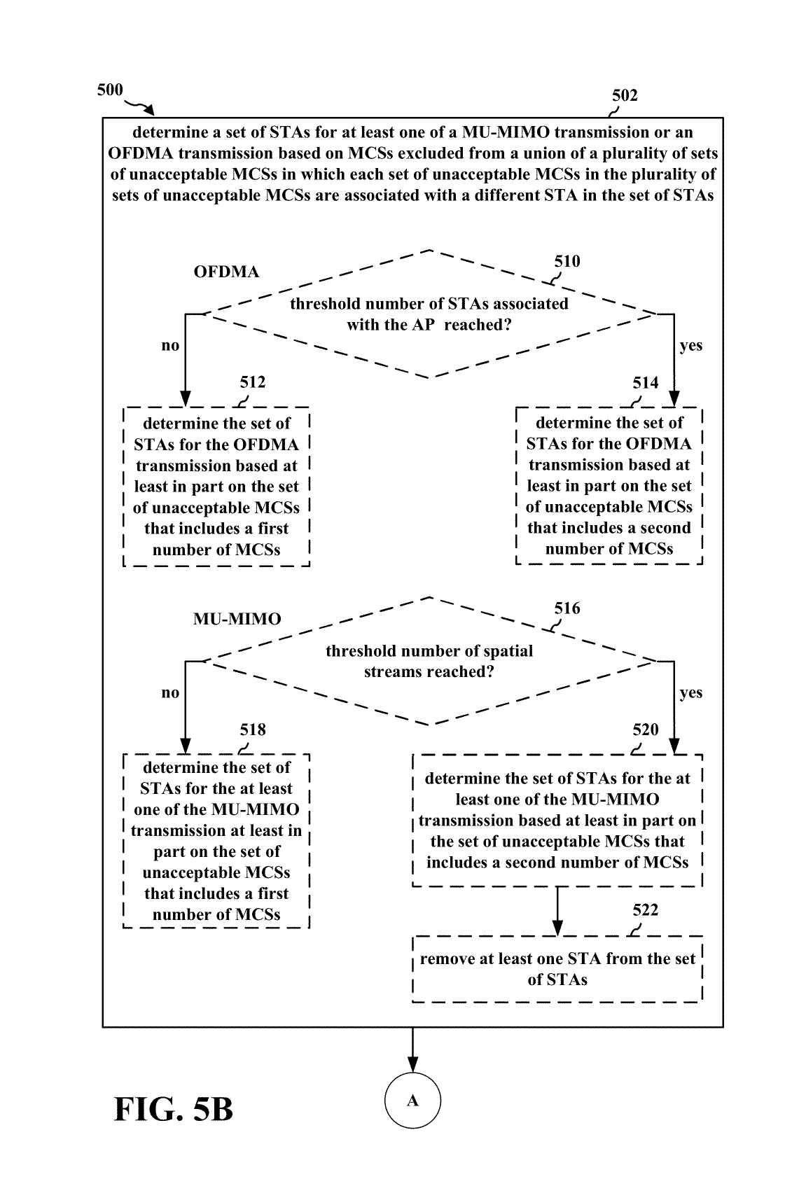

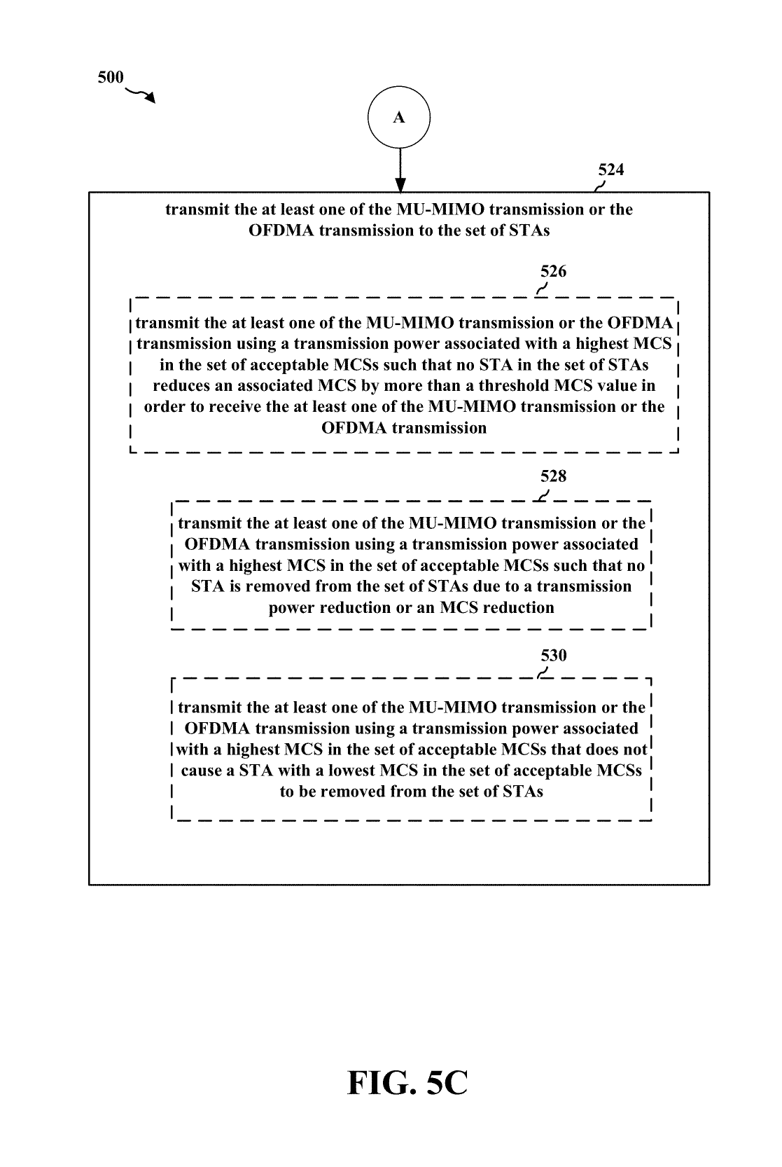

FIGS. 5A-5C are a flowchart of an example method 500 of grouping STAs for a multi-user transmission based on excluded MCS subsets in accordance with certain aspects of the disclosure. The method 500 may be performed using an AP (e.g., the AP 104, 302, the wireless communication device 402, 600) in communication with a first group of mobile stations (e.g., the STA 112, 116, first group of mobile stations 304) and a second group of mobile stations (e.g., the STA 112, 116, second group of mobile stations 306). In FIGS. 5A-5C, optional operations are indicated with dashed lines.

Referring to FIG. 5A, at 502, the AP may determine a set of STAs for at least one of a MU-MIMO transmission or an OFDMA transmission. In certain aspects, the set of STAs may be associated with a set of acceptable MCSs determined based on MCSs excluded from a union of a plurality of sets of unacceptable MCSs. In certain other aspects, each set of unacceptable MCSs in the plurality of sets of unacceptable MCSs may be associated with a different STA in the set of STAs. In certain other aspects, the set of acceptable MCSs associated with the set of STAs may change as additional STAs are included in the set of STAs. For example, referring to FIG. 3A, the AP 302 may determine 301 a first group of mobile stations 304 from a list of mobile stations. In certain implementations, each mobile station in the first group of mobile stations may not be associated with a plurality of different first excluded MCS subsets. In certain configurations, the excluded MCS subset (e.g., the set of unacceptable MCSs) associated with a reference MCS (e.g., a first MCS associated with a first mobile station in the first group of mobile stations 304) may be designed to achieve different compromise levels among data rate degradation, MAC efficiency, and scheduling latency as discussed supra with respect to FIGS. 2A, 2B, and 2C. Referring to FIG. 2D, an example union of MCS excluded subsets 245 may be a union of the MCS excluded subsets of MCS 4, MCS 5, and MCS 7 at the first comprise level as seen in FIG. 2A. The MCS excluded subset associated with MCS 4 includes MCS 9, MCS 10, and MCS 11. Similarly, the MCS excluded subset associated with MCS 5 also includes MCS 9, MCS 10, and MCS 11. The MCS excluded subset associated with MCS 7 includes MCS 0, MCS 1, MCS 2, MCS 3, and MCS 11. Thus, the union of MCS excluded subsets 345 for MCS 4, MCS 5, and MCS 7 includes MCS 0, MCS 1, MCS 2, MCS 3, MCS 9, MCS 10, and MCS 11. In other words, no STAs with MCS 0, MCS 1, MCS 2, MCS 3, MCS 9, MCS 10, or MCS 11 may be included in a group that includes STAs with MCS 4, MCS 5, and MCS 7.

At 504, the AP may determine the set of STAs for the at least one of the MU-MIMO transmission or the OFDMA transmission by grouping a first STA in the set of STAs for the at least one of the MU-MIMO transmission or the OFDMA transmission. In certain aspects, the first STA may be associated with a first set of acceptable MCSs and a first set of unacceptable MCSs. For example, referring to FIG. 3A, the AP 302 may group 303 a first mobile station in the list of mobile stations in the first group of mobile stations 304. In one aspect, the first mobile station may be associated with a first MCS. For example, the AP 302 may group the mobile station with the highest rank in the list (e.g., the first mobile station) in the first group of mobile stations 304.

At 506, the AP may determine the set of STAs for the at least one of the MU-MIMO transmission or the OFDMA transmission by grouping a second STA in the set of STAs for the at least one of the MU-MIMO transmission or the OFDMA transmission when a second set of acceptable MCSs associated with the second STA does not include an MCS excluded from the first set of unacceptable MCSs. In certain aspects, the second STA may be associated with a second set of unacceptable MCSs. For example, referring to FIG. 3A, the AP 302 may determine 305 if a second MCS associated with a second mobile station in the list of mobile stations is included in a first excluded MCS subset associated with the first MCS. For example, assume that the second mobile station (e.g., the mobile station with the second highest rank in the list) is associated with MCS 7. In addition, assume that the first mobile station is associated with MCS 5, and that the first excluded MCS subset associated with MCS 5 includes MCS 0, MCS 9, MCS 10, and MCS 11. Because MCS 7 is not included in the first excluded MCS subset associated with MCS 5, the AP 302 may determine 305 that the second mobile station can be grouped in the first group of mobile stations 304.

At 508, the AP may determine the set of STAs for the at least one of the MU-MIMO transmission or the OFDMA transmission by grouping a third STA in the set of STAs for the at least one of the MU-MIMO transmission or the OFDMA transmission when a third set of acceptable MCSs associated with the third STA does not include an MCS excluded from the first set of unacceptable MCSs or the second set of unacceptable MCSs. For example, referring to FIG. 3B, the AP 302 may group 311 the third mobile station in the first group of mobile stations 304 upon determining that the third MCS is not included in the first excluded MCS subset or the second excluded MCS subset.

Referring to FIG. 5B, at 510, when the at least one of the MU-MIMO transmission or the OFDMA transmission includes the OFDMA transmission, the AP may determine the set of STAs for the OFDMA transmission by determining whether a threshold number of STAs associated with the AP has been reached. For example, referring to FIG. 3D, the AP 302 may determine 321 if a threshold number of STAs communicating with the AP 302 has been reached. In certain implementations, the AP 302 may determine 321 if the threshold number of STAs communicating with the AP 302 has been reached prior to transmitting a OFDMA transmission.

When the AP determines (at 510) that the threshold number of STAs associated with the AP has not been reached, the operation moves to 512. Otherwise, when the AP determines (at 510) that the threshold number of STAs associated with the AP has been reached, the operation moves to 514.

At 512, the AP may determine the set of STAs for the OFDMA transmission by determining the set of STAs for the OFDMA transmission based at least in part on the set of unacceptable MCSs that includes a first number of MCSs upon determining (at 510) that the threshold number of STAs associated with the AP has not been reached. For example, referring to FIG. 3D, when the AP 302 determines 321 that the threshold number of STAs communicating with the AP has not been reached, the AP 302 may determine the set of STAs for the OFDMA transmission based at least in part on the set of unacceptable MCSs that includes a first number of MCSs (e.g., compromise level 1—see FIG. 2A).

At 514, the AP may determine the set of STAs for the OFDMA transmission by determining the set of STAs for the OFDMA transmission based at least in part on the set of unacceptable MCSs that includes a second number of MCSs upon determining (at 510) that the threshold number of STAs associated with the AP has been reached. In certain aspects, the first number of MCSs may be greater than the second number of MCSs. For example, referring to FIG. 3D, when the AP 302 determines 321 that the threshold number of STAs communicating with the AP has been reached, the AP 302 may determine the set of STAs for the OFDMA transmission based at least in part on the set of unacceptable MCSs that includes a second number of MCSs (e.g., compromise level 2—see FIG. 2B), where the second number of MCSs is less than the first number of MCSs.

At 516, when the at least one of the MU-MIMO transmission or the OFDMA transmission includes the MU-MIMO transmission, the AP may determine the set of STAs for the MU-MIMO transmission by determining whether a threshold number of spatial streams used by the AP has been reached. For example, referring to FIG. 3D, the AP 302 may determine 321 if all spatial streams are utilized. In certain aspects, the AP 302 may determine 321 if all spatial streams are utilized prior to the AP 302 transmitting a MU-MIMO transmission to a group of mobile stations.

When the AP determines (at 516) that the threshold number of spatial streams used by the AP has not been reached, the operation moves to 518. Otherwise, when the AP determines (at 516) that the threshold number of spatial streams used by the AP has been reached, the operation moves to 520.

At 518, the AP may determine the set of STAs for the MU-MIMO transmission by determining the set of STAs for the MU-MIMO transmission at least in part on the set of unacceptable MCSs that includes a first number of MCSs upon determining (at 516) that the threshold number of spatial streams used by the AP has not been reached. For example, referring to FIG. 3D, when the AP 302 determines 321 that all spatial streams are not utilized, a first number of MCS may be included in the plurality of different first excluded MCS subsets (e.g., compromise level 2—see FIG. 2B).

At 520, the AP may determine the set of STAs for the MU-MIMO transmission by determining the set of STAs for the MU-MIMO transmission based at least in part on the set of unacceptable MCSs that includes a second number of MCSs upon determining (at 516) that the threshold number of spatial streams used by the AP has been reached. In certain aspects, the first number of MCSs may be less than the second number of MCSs. For example, referring to FIG. 3D, when the AP 302 determines 321 that all spatial streams are utilized, a second number of MCSs that is less than the first number of MCSs may be included in the plurality of different first excluded MCS subsets (e.g., compromise level 1—see FIG. 2A).

At 522, the AP may determine the set of STAs for the MU-MIMO transmission by removing at least one STA from the set of STAs upon determining (at 516) that the threshold number of spatial streams used by the AP has been reached. For example, referring to FIG. 3D, the AP 302 may remove 323 at least one mobile station from the first group of mobile stations upon determining that all of the spatial streams are utilized. For example, assume that a first mobile station with MCS 3, a second mobile station with MCS 4, and a third mobile station with MCS 8 are initially grouped together for a multi-user transmission based on compromise level 2 Excluded MCS subsets (e.g., before all of the spatial streams are utilized—see FIG. 2B). When the AP 302 determines that all of the spatial streams have been utilized, the AP 302 may switch from compromise level 2 to compromise level 1, and remove the third mobile station from the group since MCS 8 is part of the union of Excluded MCS subsets associated with MCS 3 and MCS 4 when using compromise level 1 (e.g., the union includes MCS 7, MCS, 8, MCS 9, MCS, 10, MCS 11).

Referring to FIG. 5C, at 524, the AP may transmit the at least one of the MU-MIMO transmission or the OFDMA transmission to the set of STAs. For example, referring to FIG. 3D, the AP 302 may transmit a first multi-user transmission 327 to the first group of mobile stations 304 and a second multi-user transmission 329 to the second group of mobile stations 306.

At 526, the AP may transmit the at least one of the MU-MIMO transmission or the OFDMA transmission to the set of STAs by transmitting the at least one of the MU-MIMO transmission or the OFDMA transmission using a transmission power associated with a highest MCS in the set of acceptable MCSs such that no STA in the set of STAs reduces an associated MCS by more than a threshold MCS value in order to receive the at least one of the MU-MIMO transmission or the OFDMA transmission. For example, referring to FIG. 2A, an AP may be configured to transmit the multi-user transmission using the transmission power associated with the highest MCS STA in the set of STAs when using the first compromise level. The excluded and non-excluded MCS subsets in the first compromise level depicted in FIG. 2A may be selected such that when the transmission power of the highest MCS STA in the set of STAs is used for the multi-user transmission, no STA in the set of STAs will have to reduce its MCS by more than one MCS to properly receive the multi-user transmission. In other words, the difference between transmission power in the MCS non-excluded regions for any reference MCS is no greater than a predetermined value (e.g., 2 dB). As mentioned above, different MCSs (e.g., MCS 0, MCS 1, MCS 2, MCS 3, MCS 4, MCS 5, MCS 6, MCS 7, MCS 8, MCS 9 MCS 10, MCS 11, etc.) may have different transmission powers associated therewith and may use different modulation schemes that provide different amounts of data throughput. Generally, the higher the MCS the lower the associated transmission power, and the higher the data throughput. For example, the transmission power associated with MCS 9 may be lower than the transmission power associated with MCS 7, and the modulation scheme associated with MCS 9 may provide a higher data throughput than the modulation scheme associated with MCS 7. By way of example, assume that an AP groups a first STA with MCS 7 and a second STA with MCS 9 for a multi-user transmission using the first compromise level depicted in FIG. 2A. In this example, the AP may use the transmission power associated with MCS 9 for the multi-user transmission. Hence, the second STA with MCS 9 may use the modulation scheme associated with MCS 9 for receiving the multi-user transmission. However, the first STA with MCS 7 may need to reduce its MCS to an MCS with a lower data throughput modulation scheme because the transmission power of the multi-user transmission is lower than the transmission power associated with MCS 7. If the first STA with MCS 7 maintains the modulation scheme associated with MCS 7, the first STA may be unable to reliably receive the multi-user transmission because the transmission power is lowered. In another example, assume the modulation scheme associated with MCS 7 includes 16-quadrature amplitude modulation (16-QAM) that transmits 4 bits per symbol, and that the modulation scheme associated with MCS 6 includes QPSK that transmits two bits per symbol. In terms of a constellation diagram, 16-QAM uses sixteen points on a square grid with equal horizontal and vertical spacing, and four points per quadrant. When the transmission power for 16-QAM is reduced, the first STA with MCS 7 may not be able to properly receive and decode the signal transmitted using 16-QAM because the constellation points may shift as a consequence of increased signal noise, interference, etc. (e.g., due to the reduction in transmission power). When there are multiple constellation points per quadrant, as in 16-QAM, the increased signal noise and/or interference may cause the constellation points to be shifted to a position that is similar to another of the constellation points. Consequently, the first STA may be unable to determine which of the shifted constellation points correspond to the transmitted symbols. Hence, the first STA may reduce its associated MCS from MCS 7 to MCS 6 in order to increase the chances of properly receiving and decoding the multi-user transmission. The constellation diagram for QPSK uses four symbols on a square grid with equal horizontal and vertical spacing, and one symbol per quadrant. By using a less robust modulation scheme such as QPSK, even when the transmission power is reduced, the first STA may still receive and decode the multi-user transmission. This is because even if the constellation points for QPSK are shifted within their respective quadrants, the first STA may still be able to determine the correct symbols (00, 01, 10, 11) because with QPSK there is only a single constellation point per quadrant. Hence, using the techniques described above in connection with FIG. 2A, all STAs grouped for a multi-user transmission may be able to receive the multi-user transmission even when the transmission power for certain STAs in the group is reduced.

At 528, the AP may transmit the at least one of the MU-MIMO transmission or the OFDMA transmission to the set of STAs by transmitting the at least one of the MU-MIMO transmission or the OFDMA transmission using a transmission power associated with a highest MCS in the set of acceptable MCSs such that no STA is removed from the set of STAs due to a transmission power reduction or an MCS reduction. For example, referring to FIG. 2B, when using the second compromise level, an AP may be configured to use the transmission power associated the highest MCS mobile station in a group for the multi-user transmission such that no STA is removed from the set of STAs due to a transmission power reduction or an MCS reduction. For example, assume that an AP groups a first STA with MCS 3 and a second STA with MCS 10 for a multi-user transmission. The AP may use the transmission power associated with the second STA with MCS 10 to transmit the multi-user transmission. In addition, the transmission power difference between MCS 3 and MCS 10 is 8 dBm, and that the transmission power difference between MCS 0 and MCS 3 is 9 dBm. Because the transmission power associated with the first STA with MCS 3 is reduced by less than 9 dBm, the first STA may reduce its MCS to MCS 0, and thus, remain in the group. However, if the transmission power associated with MCS 3 is reduced by a value greater than or equal to 9 dBm (e.g., if the transmission power difference between MCS 3 and MCS 10 is greater than or equal to 9 dBm), the first STA may be removed from the group since the STA cannot reduce its MCS lower than MCS 0. The excluded MCS subsets of the second compromise level are selected such that no STA may be removed from the group due to reducing transmission power, e.g., the transmission power difference between the highest MCS STA in a group and all other STAs in the group is less than the transmission power difference between MCS 0 and all other STAs in the group.

At 530, the AP may transmit the at least one of the MU-MIMO transmission or the OFDMA transmission to the set of STAs by transmitting the at least one of the MU-MIMO transmission or the OFDMA transmission using a transmission power associated with a highest MCS in the set of acceptable MCSs that does not cause a STA with a lowest MCS in the set of acceptable MCSs to be removed from the set of STAs. For example, referring to FIG. 2C, the third compromise level may configure an AP to use the transmission power of the highest MCS in a mobile station group without pushing the lowest MCS mobile station out of the group. For example, assume that an AP groups a first STA with MCS 2, a second STA with MCS 5, and a third STA with MCS 7 for a multi-user transmission. The AP may use the transmission power associated with the MCS 7 if the transmission power difference between MCS 2 and MCS 7 is less than the transmission power difference of MCS 0 and MCS 2. However, if the transmission power difference between MCS 2 and MCS 7 is greater than the transmission power of MCS 0 and MCS 2, then the AP may use the transmission power of MCS 5 for the multi-user transmission so long as the power difference between MCS 2 and MCS 5 is less than the power difference between MCS 0 and MCS 2. Further, if the transmission power difference between MCS 2 and MCS 7 and MCS 2 and MCS 5 are both greater than the transmission power difference of MCS 0 and MCS 2, the AP may use the transmission power associated with MCS 2 for the multi-user transmission.

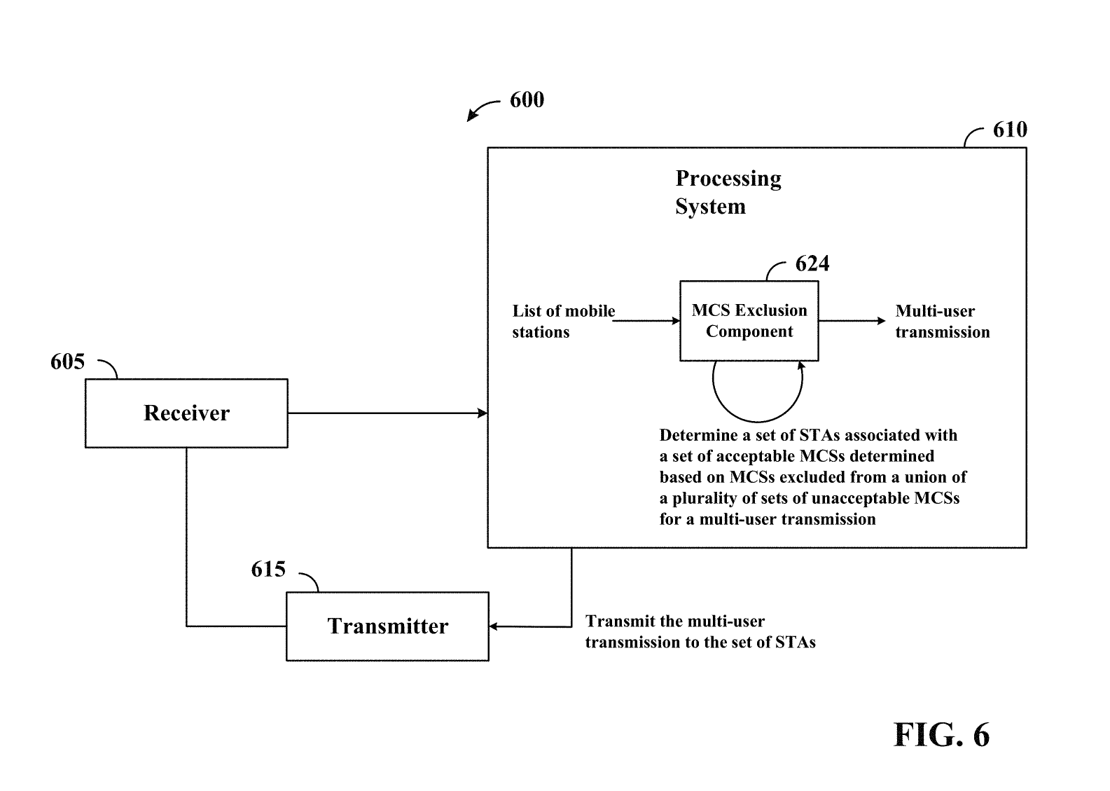

FIG. 6 is a functional block diagram of an example wireless communication device 600 that may group STAs for a multi-user transmission based on excluded MCS subsets. The wireless communication device 600 may include a receiver 605, a processing system 610, and a transmitter 615. The processing system 610 may include an MCS exclusion component 624.

The processing system 610, the MCS exclusion component 624, and/or the transmitter 615 may be configured to determine a set of STAs for at least one of a MU-MIMO transmission or an OFDMA transmission. In certain aspects, the set of STAs may be associated with a set of acceptable MCSs determined based on MCSs excluded from a union of a plurality of sets of unacceptable MCSs. In certain other aspects, each set of unacceptable MCSs in the plurality of sets of unacceptable MCSs may be associated with a different STA in the set of STAs. In certain other aspects, the set of acceptable MCSs associated with the set of STAs may change as additional STAs are included in the set of STAs. In certain configurations, the processing system 610, the MCS exclusion component 624, and/or the transmitter 615 may be configured to determine a set of STAs for at least one of a MU-MIMO transmission or an OFDMA transmission by grouping a first STA in the set of STAs for the at least one of the MU-MIMO transmission or the OFDMA transmission. In certain aspects, the first STA may be associated with a first set of acceptable MCSs and a first set of unacceptable MCSs. In certain other configurations, the processing system 610, the MCS exclusion component 624, and/or the transmitter 615 may be configured to determine a set of STAs for at least one of a MU-MIMO transmission or an OFDMA transmission by grouping a second STA in the set of STAs for the at least one of the MU-MIMO transmission or the OFDMA transmission when a second set of acceptable MCSs associated with the second STA does not include an MCS excluded from the first set of unacceptable MCSs. In certain aspects, the second STA may be associated with a second set of unacceptable MCSs. In certain other configurations, the processing system 610, the MCS exclusion component 624, and/or the transmitter 615 may be configured to determine a set of STAs for at least one of a MU-MIMO transmission or an OFDMA transmission by grouping a third STA in the set of STAs for the at least one of the MU-MIMO transmission or the OFDMA transmission when a third set of acceptable MCSs associated with the third STA does not include an MCS excluded from the first set of unacceptable MCSs or the second set of unacceptable MCSs. In certain other configurations, when the at least one of the MU-MIMO transmission or the OFDMA transmission includes the OFDMA transmission, the processing system 610, the MCS exclusion component 624, and/or the transmitter 615 may be configured to determine the set of STAs for the OFDMA transmission by determining whether a threshold number of STAs associated with the AP has been reached. In certain other configurations, when the at least one of the MU-MIMO transmission or the OFDMA transmission includes the OFDMA transmission, the processing system 610, the MCS exclusion component 624, and/or the transmitter 615 may be configured to determine the set of STAs for the OFDMA transmission by determining the set of STAs for the OFDMA transmission based at least in part on the set of unacceptable MCSs that includes a first number of MCSs upon determining that the threshold number of STAs associated with the AP has not been reached. In certain other configurations, when the at least one of the MU-MIMO transmission or the OFDMA transmission includes the OFDMA transmission, the processing system 610, the MCS exclusion component 624, and/or the transmitter 615 may be configured to determine the set of STAs for the OFDMA transmission by determining the set of STAs for the OFDMA transmission based at least in part on the set of unacceptable MCSs that includes a second number of MCSs upon determining that the threshold number of STAs associated with the AP has been reached. In certain aspects, the first number of MCSs may be greater than the second number of MCSs. In certain other configurations, when the at least one of the MU-MIMO transmission or the OFDMA transmission includes the MU-MIMO transmission, the processing system 610, the MCS exclusion component 624, and/or the transmitter 615 may be configured to determine the set of STAs for the MU-MIMO transmission by determining whether a threshold number of spatial streams used by the AP has been reached. In certain other configurations, when the at least one of the MU-MIMO transmission or the OFDMA transmission includes the MU-MIMO transmission, the processing system 610, the MCS exclusion component 624, and/or the transmitter 615 may be configured to determine the set of STAs for the MU-MIMO transmission by determining the set of STAs for the at least one of the MU-MIMO transmission at least in part on the set of unacceptable MCSs that includes a first number of MCSs upon determining that the threshold number of spatial streams used by the AP has not been reached. In certain other configurations, when the at least one of the MU-MIMO transmission or the OFDMA transmission includes the MU-MIMO transmission, the processing system 610, the MCS exclusion component 624, and/or the transmitter 615 may be configured to determine the set of STAs for the MU-MIMO transmission by determining the set of STAs for the MU-MIMO transmission based at least in part on the set of unacceptable MCSs that includes a second number of MCSs upon determining that the threshold number of spatial streams used by the AP has been reached. In certain aspects, the first number of MCSs may be less than the second number of MCSs. In certain other configurations, when the at least one of the MU-MIMO transmission or the OFDMA transmission includes the MU-MIMO transmission, the processing system 610, the MCS exclusion component 624, and/or the transmitter 615 may be configured to determine the set of STAs for the MU-MIMO transmission by removing at least one STA from the set of STAs upon determining that the threshold number of spatial streams used by the AP has been reached. In certain other configurations, the processing system 610, the MCS exclusion component 624, and/or the transmitter 615 may be configured to transmit the at least one of the MU-MIMO transmission or the OFDMA transmission to the set of STAs. In certain implementations, the processing system 610, the MCS exclusion component 624, and/or the transmitter 615 may be configured to transmit the at least one of the MU-MIMO transmission or the OFDMA transmission to the set of STAs by transmitting the at least one of the MU-MIMO transmission or the OFDMA transmission using a transmission power associated with a highest MCS in the set of acceptable MCSs such that no STA in the set of STAs reduces an associated MCS by more than a threshold MCS value in order to receive the at least one of the MU-MIMO transmission or the OFDMA transmission. In certain other implementations, the processing system 610, the MCS exclusion component 624, and/or the transmitter 615 may be configured to transmit the at least one of the MU-MIMO transmission or the OFDMA transmission to the set of STAs by transmitting the at least one of the MU-MIMO transmission or the OFDMA transmission using a transmission power associated with a highest MCS in the set of acceptable MCSs such that no STA is removed from the set of STAs due to a transmission power reduction or an MCS reduction. In certain other implementations, the processing system 610, the MCS exclusion component 624, and/or the transmitter 615 may be configured to transmit the at least one of the MU-MIMO transmission or the OFDMA transmission to the set of STAs by transmitting the at least one of the MU-MIMO transmission or the OFDMA transmission using a transmission power associated with a highest MCS in the set of acceptable MCSs that does not cause a STA with a lowest MCS in the set of acceptable MCSs to be removed from the set of STAs.

The processing system 610, the MCS exclusion component 624, and/or the transmitter 615 may be configured to perform one or more functions discussed above with respect to blocks 502, 504, 506, 508, 510, 512, 514, 516, 518, 520, 522, 524, 526, 528, 530 of FIGS. 5A-5C. The receiver 605 may correspond to the receiver 412. The processing system 610 may correspond to the processor 404. The transmitter 615 may correspond to the transmitter 410. The MCS exclusion component 624 may correspond to the MCS exclusion component 124, and/or the MCS exclusion component 424.

In one configuration, the wireless communication device 600 may include means for determining (e.g., the processing system 610, the MCS exclusion component 624, and/or the transmitter 615) a set of STAs for at least one of a MU-MIMO transmission or an OFDMA transmission. In certain aspects, the set of STAs may be associated with a set of acceptable MCSs determined based on MCSs excluded from a union of a plurality of sets of unacceptable MCSs. In certain other aspects, each set of unacceptable MCSs in the plurality of sets of unacceptable MCSs may be associated with a different STA in the set of STAs. In certain other aspects, the set of acceptable MCSs associated with the set of STAs may change as additional STAs are included in the set of STAs. In certain configurations, means for determining (e.g., the processing system 610, the MCS exclusion component 624, and/or the transmitter 615) the set of STAs for the at least one of the MU-MIMO transmission or the OFDMA transmission may be configured to group a first STA in the set of STAs for the at least one of the MU-MIMO transmission or the OFDMA transmission. In certain aspects, the first STA may be associated with a first set of acceptable MCSs and a first set of unacceptable MCSs. In certain other configurations, the means for determining (e.g., the processing system 610, the MCS exclusion component 624, and/or the transmitter 615) the set of STAs for the at least one of the MU-MIMO transmission or an OFDMA transmission may be configured to group a second STA in the set of STAs for the at least one of the MU-MIMO transmission or the OFDMA transmission when a second set of acceptable MCSs associated with the second STA does not include an MCS excluded from the first set of unacceptable MCSs. In certain aspects, the second STA may be associated with a second set of unacceptable MCSs. In certain other configurations, the means for determining (e.g., the processing system 610, the MCS exclusion component 624, and/or the transmitter 615) the set of STAs for the at least one of the MU-MIMO transmission or the OFDMA transmission may be configured to group a third STA in the set of STAs for the at least one of the MU-MIMO transmission or the OFDMA transmission when a third set of acceptable MCSs associated with the third STA does not include an MCS excluded from the first set of unacceptable MCSs or the second set of unacceptable MCSs. In certain other configurations, when the at least one of the MU-MIMO transmission or the OFDMA transmission includes the OFDMA transmission, the means for determining (e.g., the processing system 610, the MCS exclusion component 624, and/or the transmitter 615) the set of STAs for the OFDMA transmission may be configured to determine whether a threshold number of STAs associated with the AP has been reached. In certain other configurations, when the at least one of the MU-MIMO transmission or the OFDMA transmission includes the OFDMA transmission, the means for determining (e.g., the processing system 610, the MCS exclusion component 624, and/or the transmitter 615) the set of STAs for the OFDMA transmission may be configured to determine the set of STAs for the OFDMA transmission based at least in part on the set of unacceptable MCSs that includes a first number of MCSs upon determining that the threshold number of STAs associated with the AP has not been reached. In certain other configurations, when the at least one of the MU-MIMO transmission or the OFDMA transmission includes the OFDMA transmission, the means for determining (e.g., the processing system 610, the MCS exclusion component 624, and/or the transmitter 615) the set of STAs for the OFDMA transmission may be configured to determine the set of STAs for the OFDMA transmission based at least in part on the set of unacceptable MCSs that includes a second number of MCSs upon determining that the threshold number of STAs associated with the AP has been reached. In certain aspects, the first number of MCSs may be greater than the second number of MCSs. In certain other configurations, when the at least one of the MU-MIMO transmission or the OFDMA transmission includes the MU-MIMO transmission, the means for determining (e.g., the processing system 610, the MCS exclusion component 624, and/or the transmitter 615) the set of STAs for the MU-MIMO transmission may be configured to determine whether a threshold number of spatial streams used by the AP has been reached. In certain other configurations, when the at least one of the MU-MIMO transmission or the OFDMA transmission includes the MU-MIMO transmission, the means for determining (e.g., the processing system 610, the MCS exclusion component 624, and/or the transmitter 615) the set of STAs for the MU-MIMO transmission may be configured to determine the set of STAs for the at least one of the MU-MIMO transmission at least in part on the set of unacceptable MCSs that includes a first number of MCSs upon determining that the threshold number of spatial streams used by the AP has not been reached. In certain other configurations, when the at least one of the MU-MIMO transmission or the OFDMA transmission includes the MU-MIMO transmission, the means for determining (e.g., the processing system 610, the MCS exclusion component 624, and/or the transmitter 615) the set of STAs for the MU-MIMO transmission may be configured to determine the set of STAs for the MU-MIMO transmission based at least in part on the set of unacceptable MCSs that includes a second number of MCSs upon determining that the threshold number of spatial streams used by the AP has been reached. In certain aspects, the first number of MCSs may be less than the second number of MCSs. In certain other configurations, when the at least one of the MU-MIMO transmission or the OFDMA transmission includes the MU-MIMO transmission, the means for determining (e.g., the processing system 610, the MCS exclusion component 624, and/or the transmitter 615) the set of STAs for the MU-MIMO transmission may be configured to remove at least one STA from the set of STAs upon determining that the threshold number of spatial streams used by the AP has been reached. In certain other configurations, the wireless communication device 600 may include means for transmitting (e.g., the processing system 610, the MCS exclusion component 624, and/or the transmitter 615) the at least one of the MU-MIMO transmission or the OFDMA transmission to the set of STAs. In certain implementations, the means for transmitting (e.g., the processing system 610, the MCS exclusion component 624, and/or the transmitter 615) the at least one of the MU-MIMO transmission or the OFDMA transmission to the set of STAs may be configured to transmit the at least one of the MU-MIMO transmission or the OFDMA transmission using a transmission power associated with a highest MCS in the set of acceptable MCSs such that no STA in the set of STAs reduces an associated MCS by more than a threshold MCS value in order to receive the at least one of the MU-MIMO transmission or the OFDMA transmission. In certain other implementations, the means for transmitting (e.g., the processing system 610, the MCS exclusion component 624, and/or the transmitter 615) the at least one of the MU-MIMO transmission or the OFDMA transmission to the set of STAs may be configured to transmit the at least one of the MU-MIMO transmission or the OFDMA transmission using a transmission power associated with a highest MCS in the set of acceptable MCSs such that no STA is removed from the set of STAs due to a transmission power reduction or an MCS reduction. In certain other implementations, the means for transmitting (e.g., the processing system 610, the MCS exclusion component 624, and/or the transmitter 615) the at least one of the MU-MIMO transmission or the OFDMA transmission to the set of STAs may be configured to transmit the at least one of the MU-MIMO transmission or the OFDMA transmission using a transmission power associated with a highest MCS in the set of acceptable MCSs that does not cause a STA with a lowest MCS in the set of acceptable MCSs to be removed from the set of STAs.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof' include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof' may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of an access point (AP), comprising:
determining a set of stations (STAs) for at least one of a multi-user multiple input multiple output (MU-MIMO) transmission or an orthogonal frequency division multiple access (OFDMA) transmission, the set of STAs being associated with a set of acceptable modulation and coding schemes (MCSs) determined based on MCSs excluded from a union of a plurality of sets of unacceptable MCSs, each set of unacceptable MCSs in the plurality of sets of unacceptable MCSs being associated with a different STA in the set of STAs; and
transmitting the at least one of the MU-MIMO transmission or the OFDMA transmission to the set of STAs.

2. The method of claim 1, wherein the set of acceptable MCSs associated with the set of STAs changes as additional STAs are included in the set of STAs.

3. The method of claim 1, wherein the determining the set of STAs for the at least one of the MU-MIMO transmission or the OFDMA transmission comprises:
grouping a first STA in the set of STAs for the at least one of the MU-MIMO transmission or the OFDMA transmission, the first STA being associated with a first set of acceptable MCSs and a first set of unacceptable MCSs;
grouping a second STA in the set of STAs for the at least one of the MU-MIMO transmission or the OFDMA transmission when a second set of acceptable MCSs associated with the second STA does not include an MCS excluded from the first set of unacceptable MCSs, the second STA being associated with a second set of unacceptable MCSs; and
grouping a third STA in the set of STAs for the at least one of the MU-MIMO transmission or the OFDMA transmission when a third set of acceptable MCSs associated with the third STA does not include an MCS excluded from the first set of unacceptable MCSs or the second set of unacceptable MCSs.

4. The method of claim 1, wherein the transmitting the at least one of the MU-MIMO transmission or the OFDMA transmission to the set of STAs comprises:
transmitting the at least one of the MU-MIMO transmission or the OFDMA transmission using a transmission power associated with a highest MCS in the set of acceptable MCSs such that no STA in the set of STAs reduces an associated MCS by more than a threshold MCS value in order to receive the at least one of the MU-MIMO transmission or the OFDMA transmission.

5. The method of claim 1, wherein the transmitting the at least one of the MU-MIMO transmission or the OFDMA transmission to the set of STAs comprises:
transmitting the at least one of the MU-MIMO transmission or the OFDMA transmission using a transmission power associated with a highest MCS in the set of acceptable MCSs such that no STA is removed from the set of STAs due to a transmission power reduction or an MCS reduction.

6. The method of claim 1, wherein the transmitting the at least one of the MU-MIMO transmission or the OFDMA transmission to the set of STAs comprises:
transmitting the at least one of the MU-MIMO transmission or the OFDMA transmission using a transmission power associated with a highest MCS in the set of acceptable MCSs that does not cause a STA with a lowest MCS in the set of acceptable MCSs to be removed from the set of STAs.

7. The method of claim 1, wherein when the at least one of the MU-MIMO transmission or the OFDMA transmission includes the OFDMA transmission, the determining the set of STAs for the OFDMA transmission comprises:
determining whether a threshold number of STAs associated with the AP has been reached;
determining the set of STAs for the OFDMA transmission based at least in part on the set of unacceptable MCSs that includes a first number of MCSs upon determining that the threshold number of STAs associated with the AP has not been reached; and
determining the set of STAs for the OFDMA transmission based at least in part on the set of unacceptable MCSs that includes a second number of MCSs upon determining that the threshold number of STAs associated with the AP has been reached, the first number of MCSs being greater than the second number of MCSs.

8. The method of claim 1, wherein when the at least one of the MU-MIMO transmission or the OFDMA transmission includes the MU-MIMO transmission, the determining the set of STAs for the MU-MIMO transmission comprises:
determining whether a threshold number of spatial streams used by the AP has been reached;
determining the set of STAs for the MU-MIMO transmission at least in part on the set of unacceptable MCSs that includes a first number of MCSs upon determining that the threshold number of spatial streams used by the AP has not been reached; and
determining the set of STAs for the MU-MIMO transmission based at least in part on the set of unacceptable MCSs that includes a second number of MCSs upon determining that the threshold number of spatial streams used by the AP has been reached, the first number of MCSs being less than the second number of MCSs.

9. The method of claim 8, wherein when the at least one of the MU-MIMO transmission or the OFDMA transmission includes the MU-MIMO transmission, the determining the set of STAs for the MU-MIMO transmission further comprises:
removing at least one STA from the set of STAs upon determining that the threshold number of spatial streams used by the AP has been reached.

10. An apparatus for wireless communication of an access point (AP), comprising:
means for determining a set of stations (STAs) for at least one of a multi-user multiple input multiple output (MU-MIMO) transmission or an orthogonal frequency division multiple access (OFDMA) transmission, the set of STAs being associated with a set of acceptable MCSs determined based on MCSs excluded from a union of a plurality of sets of unacceptable MCSs, each set of unacceptable MCSs in the plurality of sets of unacceptable MCSs being associated with a different STA in the set of STAs; and
means for transmitting the at least one of the MU-MIMO transmission or the OFDMA transmission to the set of STAs.

11. The apparatus of claim 10, wherein the set of acceptable MCSs associated with the set of STAs changes as additional STAs are included in the set of STAs.

12. The apparatus of claim 10, wherein the determining the set of STAs for the at least one of the MU-MIMO transmission or the OFDMA transmission comprises:
means for grouping a first STA in the set of STAs for the at least one of the MU-MIMO transmission or the OFDMA transmission, the first STA being associated with a first set of acceptable MCSs and a first set of unacceptable MCSs;
means for grouping a second STA in the set of STAs for the at least one of the MU-MIMO transmission or the OFDMA transmission when a second set of acceptable MCSs associated with the second STA does not include an MCS excluded from the first set of unacceptable MCSs, the second STA being associated with a second set of unacceptable MCSs; and
means for grouping a third STA in the set of STAs for the at least one of the MU-MIMO transmission or the OFDMA transmission when a third set of acceptable MCSs associated with the third STA does not include an MCS excluded from the first set of unacceptable MCSs or the second set of unacceptable MCSs.

13. The apparatus of claim 10, wherein the means for transmitting the at least one of the MU-MIMO transmission or the OFDMA transmission to the set of STAs is configured to:
transmit the at least one of the MU-MIMO transmission or the OFDMA transmission using a transmission power associated with a highest MCS in the set of acceptable MCSs such that no STA in the set of STAs reduces an associated MCS by more than a threshold MCS value in order to receive the at least one of the MU-MIMO transmission or the OFDMA transmission.

14. The apparatus of claim 10, wherein the means for transmitting the at least one of the MU-MIMO transmission or the OFDMA transmission to the set of STAs is configured to:
transmit the at least one of the MU-MIMO transmission or the OFDMA transmission using a transmission power associated with a highest MCS in the set of acceptable MCSs such that no STA is removed from the set of STAs due to a transmission power reduction or an MCS reduction.

15. The apparatus of claim 10, wherein the means for transmitting the at least one of the MU-MIMO transmission or the OFDMA transmission to the set of STAs is configured to:
transmit the at least one of the MU-MIMO transmission or the OFDMA transmission using a transmission power associated with a highest MCS in the set of acceptable MCSs that does not cause a STA with a lowest MCS in the set of acceptable MCSs to be removed from the set of STAs.

16. The apparatus of claim 10, wherein when the at least one of the MU-MIMO transmission or the OFDMA transmission includes the OFDMA transmission, the means for determining the set of STAs for the OFDMA transmission is configured to:
determine whether a threshold number of STAs associated with the AP has been reached;
determine the set of STAs for the OFDMA transmission based at least in part on the set of unacceptable MCSs that includes a first number of MCSs upon determining that the threshold number of STAs associated with the AP has not been reached; and
determine the set of STAs for the OFDMA transmission based at least in part on the set of unacceptable MCSs that includes a second number of MCSs upon determining that the threshold number of STAs associated with the AP has been reached, the first number of MCSs being greater than the second number of MCSs.

17. The apparatus of claim 10, wherein when the at least one of the MU-MIMO transmission or the OFDMA transmission includes the MU-MIMO transmission, the means for determining the set of STAs for the MU-MIMO transmission is configured to:
determine whether a threshold number of spatial streams used by the AP has been reached;
determine the set of STAs for the MU-MIMO transmission at least in part on the set of unacceptable MCSs that includes a first number of MCSs upon determining that the threshold number of spatial streams used by the AP has not been reached; and
determine the set of STAs for the MU-MIMO transmission based at least in part on the set of unacceptable MCSs that includes a second number of MCSs upon determining that the threshold number of spatial streams used by the AP has been reached, the first number of MCSs being less than the second number of MCSs.

18. The apparatus of claim 17, wherein when the at least one of the MU-MIMO transmission or the OFDMA transmission includes the MU-MIMO transmission, the means for determining the set of STAs for the MU-MIMO transmission further comprises:
remove at least one STA from the set of STAs upon determining that the threshold number of spatial streams used by the AP has been reached.

19. An apparatus for wireless communication of an access point (AP), comprising:
a memory; and
at least one processor coupled to the memory and configured to:
determine a set of stations (STAs) for at least one of a multi-user multiple input multiple output (MU-MIMO) transmission or an orthogonal frequency division multiple access (OFDMA) transmission, the set of STAs being associated with a set of acceptable MCSs determined based on MCSs excluded from a union of a plurality of sets of unacceptable MCSs, each set of unacceptable MCSs in the plurality of sets of unacceptable MCSs being associated with a different STA in the set of STAs; and
transmit the at least one of the MU-MIMO transmission or the OFDMA transmission to the set of STAs.

20. The apparatus of claim 19, wherein the set of acceptable MCSs associated with the set of STAs changes as additional STAs are included in the set of STAs.

21. The apparatus of claim 19, wherein the at least one processor is configured to determine the set of STAs for the at least one of the MU-MIMO transmission or the OFDMA transmission by:
grouping a first STA in the set of STAs for the at least one of the MU-MIMO transmission or the OFDMA transmission, the first STA being associated with a first set of acceptable MCSs and a first set of unacceptable MCSs;
grouping a second STA in the set of STAs for the at least one of the MU-MIMO transmission or the OFDMA transmission when a second set of acceptable MCSs associated with the second STA does not include an MCS excluded from the first set of unacceptable MCSs, the second STA being associated with a second set of unacceptable MCSs; and
grouping a third STA in the set of STAs for the at least one of the MU-MIMO transmission or the OFDMA transmission when a third set of acceptable MCSs associated with the third STA does not include an MCS excluded from the first set of unacceptable MCSs or the second set of unacceptable MCSs.

22. The apparatus of claim 19, wherein the at least one processor is configured to transmit the at least one of the MU-MIMO transmission or the OFDMA transmission to the set of STAs by:
transmitting the at least one of the MU-MIMO transmission or the OFDMA transmission using a transmission power associated with a highest MCS in the set of acceptable MCSs such that no STA in the set of STAs reduces an associated MCS by more than a threshold MCS value in order to receive the at least one of the MU-MIMO transmission or the OFDMA transmission.

23. The apparatus of claim 19, wherein the at least one processor is configured to transmit the at least one of the MU-MIMO transmission or the OFDMA transmission to the set of STAs by:
transmitting the at least one of the MU-MIMO transmission or the OFDMA transmission using a transmission power associated with a highest MCS in the set of acceptable MCSs such that no STA is removed from the set of STAs due to a transmission power reduction or an MCS reduction.

24. The apparatus of claim 19, wherein the at least one processor is configured to transmit the at least one of the MU-MIMO transmission or the OFDMA transmission to the set of STAs by:
transmitting the at least one of the MU-MIMO transmission or the OFDMA transmission using a transmission power associated with a highest MCS in the set of acceptable MCSs that does not cause a STA with a lowest MCS in the set of acceptable MCSs to be removed from the set of STAs.

25. The apparatus of claim 19, wherein when the at least one of the MU-MIMO transmission or the OFDMA transmission includes the OFDMA transmission, and wherein the at least one processing is configured to determine the set of STAs for the OFDMA transmission by:
determining whether a threshold number of STAs associated with the AP has been reached;
determining the set of STAs for the OFDMA transmission based at least in part on the set of unacceptable MCSs that includes a first number of MCSs upon determining that the threshold number of STAs associated with the AP has not been reached; and
determining the set of STAs for the OFDMA transmission based at least in part on the set of unacceptable MCSs that includes a second number of MCSs upon determining that the threshold number of STAs associated with the AP has been reached, the first number of MCSs being greater than the second number of MCSs.

26. The apparatus of claim 19, wherein when the at least one of the MU-MIMO transmission or the OFDMA transmission includes the MU-MIMO transmission, and wherein the at least one processor is configured to determine the set of STAs for the MU-MIMO transmission by:
determining whether a threshold number of spatial streams used by the AP has been reached;
determining the set of STAs for the MU-MIMO transmission at least in part on the set of unacceptable MCSs that includes a first number of MCSs upon determining that the threshold number of spatial streams used by the AP has not been reached; and
determining the set of STAs for the MU-MIMO transmission based at least in part on the set of unacceptable MCSs that includes a second number of MCSs upon determining that the threshold number of spatial streams used by the AP has been reached, the first number of MCSs being less than the second number of MCSs.

27. The apparatus of claim 26, wherein when the at least one of the MU-MIMO transmission or the OFDMA transmission includes the MU-MIMO transmission, and wherein the at least one processor is configured to determine the set of STAs for the MU-MIMO transmission by:
removing at least one STA from the set of STAs upon determining that the threshold number of spatial streams used by the AP has been reached.

28. A computer-readable medium storing computer executable code of an access point (AP), comprising code to:
determine a set of stations (STAs) for at least one of a multi-user multiple input multiple output (MU-MIMO) transmission or an orthogonal frequency division multiple access (OFDMA) transmission, the set of STAs being associated with a set of acceptable MCSs determined based on MCSs excluded from a union of a plurality of sets of unacceptable MCSs, each set of unacceptable MCSs in the plurality of sets of unacceptable MCSs being associated with a different STA in the set of STAs; and
transmit the at least one of the MU-MIMO transmission or the OFDMA transmission to the set of STAs.

29. The computer-readable medium of claim 28, wherein the set of acceptable MCSs associated with the set of STAs changes as additional STAs are included in the set of STAs.

30. The computer-readable medium of claim 29, wherein the code to determine the set of STAs for the at least one of the MU-MIMO transmission or the OFDMA transmission is configured to:
group a first STA in the set of STAs for the at least one of the MU-MIMO transmission or the OFDMA transmission, the first STA being associated with a first set of acceptable MCSs and a first set of unacceptable MCSs;
group a second STA in the set of STAs for the at least one of the MU-MIMO transmission or the OFDMA transmission when a second set of acceptable MCSs associated with the second STA does not include an MCS excluded from the first set of unacceptable MCSs, the second STA being associated with a second set of unacceptable MCSs; and
group a third STA in the set of STAs for the at least one of the MU-MIMO transmission or the OFDMA transmission when a third set of acceptable MCSs associated with the third STA does not include an MCS excluded from the first set of unacceptable MCSs or the second set of unacceptable MCSs.
